(19) United States
(12) Patent Application Publication
(10) Pub. No.: US 2024/0414708 A1
(43) Pub. Date: Dec. 12, 2024

(54) METHOD AND APPARATUS FOR PUSCH RESOURCE ALLOCATION IN WIRELESS COMMUNICATION SYSTEM

(71) Applicant: SAMSUNG ELECTRONICS CO., LTD., Suwon-si (KR)

(72) Inventors: Deokhui LEE, Suwon-si (KR); Daeun KO, Suwon-si (KR); Dongmyung KIM, Suwon-si (KR); Kitaek LEE, Suwon-si (KR); Sangho LEE, Suwon-si (KR)

(21) Appl. No.: 18/739,191

(22) Filed: Jun. 10, 2024

(30) Foreign Application Priority Data
Jun. 12, 2023 (KR) 10-2023-0074687

(51) Int. Cl. H04W 72/1268; H04L 5/00; H04W 72/231; H04W 76/20

(52) U.S. Cl. CPC H04W 72/1268; H04L 5/0051; H04W 72/231; H04W 76/20

(57) ABSTRACT

This disclosure relates to a 6G communication system for achieving high data transmission rates and ultra-low latency beyond 4G and 5G communication systems. The disclosure provides a method performed by a terminal in a wireless communication system or an apparatus related thereto, the method including receiving first information about at least one resource pattern associated with resource allocation of an uplink reference signal (RS) from a base station, receiving second information indicating one resource pattern among the at least one resource pattern from the base station, identifying a physical uplink shared channel (PUSCH) resource based on the first information and the second information, and transmitting an uplink signal to a base station based on the identified PUSCH resource.

### CROSS-REFERENCE TO RELATED APPLICATION

This application is based on and claims priority under 35 U.S.C. § 119 to Korean Patent Application No. 10-2023-0074687, filed on Jun. 12, 2023, in the Korean Intellectual Property Office, the disclosure of which is herein incorporated by reference in its entirety.

### BACKGROUND

### 1. Field

The disclosure relates to a method and an apparatus for uplink resource allocation in a wireless communication system and, more specifically, to a method and an apparatus for PUSCH resource allocation.

### 2. Description of Related Art

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

An embodiment of the disclosure provides a method and an apparatus for overcoming a case in which conventional physical uplink shared channel (PUSCH) resource allocation techniques are unable to provide an indication of PUSCH resource allocation during a sounding reference signal (SRS) resource allocation process in a communication system.

The technical subjects pursued in an embodiment of the disclosure may not be limited to the above-mentioned matters, and other technical subjects which are not mentioned may be considered from the following description of an embodiment of the disclosure by those skilled in the art to which the disclosure pertains.

In order to solve the above problems, the disclosure provides a method performed by a terminal in a wireless communication system, the method including receiving, from a base station, first information on at least one resource pattern associated with a resource allocation of an uplink reference signal (RS), receiving second information indicating one resource pattern among the at least one resource pattern from the base station, identifying a physical uplink shared channel (PUSCH) resource based on the first information and the second information, and transmitting an uplink signal to the base station based on the identified PUSCH resource.

Further, the first information is received from the base station through a radio resource control (RRC) message.

Further still, the first information is configured by a list including at least one identifier (ID) associated with the at least one resource pattern.

Furthermore, the second information is received from the base station through downlink control information (DCI).

In addition, the second information is received from the base station through a medium access control (MAC) control element (CE) message.

In order to solve the above problems, the disclosure provides a method performed by a base station in a wireless communication system, the method including transmitting first information on at least one resource pattern associated with a resource allocation of an uplink reference signal (RS) to a terminal, transmitting second information indicating one resource pattern among the at least one resource pattern to the terminal, and receiving, from the terminal, an uplink signal based on a physical uplink shared channel (PUSCH) resource, which is identified based on the first information and the second information.

Further, the first information is transmitted to the terminal through a radio resource control (RRC) message.

Further still, the first information is configured by a list comprising at least one identifier (ID) associated with the at least one resource pattern.

Furthermore, the second information is transmitted to the terminal through DCI.

In addition, the second information is transmitted to the terminal through a MAC CE message.

In order to solve the above problems, the disclosure provides a terminal in a wireless communication system, the terminal including a transceiver, and at least one processor coupled with the transceiver and configured to receive, from a base station, first information on at least one resource pattern associated with a resource allocation of an uplink reference signal (RS), receive second information indicating one resource pattern among the at least one resource pattern from the base station, identify a physical uplink shared channel (PUSCH) resource based on the first information and the second information, and transmit an uplink signal to the base station based on the identified PUSCH resource.

In order to solve the above problems, the disclosure provides a base station in a wireless communication system, the base station including a transceiver, and at least one processor coupled with the transceiver and configured to transmit first information on at least one resource pattern associated with a resource allocation of an uplink reference signal (RS) to a terminal, transmit second information indicating one resource pattern among the at least one resource pattern to the terminal, and receive, from the terminal, an uplink signal based on a physical uplink shared channel (PUSCH) resource, which is identified based on the first information and the second information.

According to an embodiment of the disclosure, a terminal receives, from a base station, resource pattern information pre-configured based on resource allocation information of an SRS during uplink resource allocation in a wireless communication system. Since there are myriad combinations of resource patterns and it is disadvantageous in terms of efficiency for the terminal to support them in real time, resource patterns primarily used in practice are pre-configured in a terminal and thus an uplink resource allocation process can be simplified.

Furthermore, according to an embodiment of the disclosure, in a wireless communication system, a terminal receives resource pattern information pre-configured by a base station and then the terminal identifies a PUSCH resource by receiving information indicating a specific resource pattern, thereby enabling uplink data transmission without causing collision, interference, and the like due to simultaneous PUSCH resource allocation in a slot in which SRS resources are transmitted.

In addition, according to an embodiment of the disclosure, resource allocation can be controlled in units of resource elements (REs) by using a resource pattern formed in units of REs in a communication system, and thus more efficient resource operation is possible.

Advantageous effects obtainable from the disclosure may not be limited to the above-mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of bandwidth part configuration in a wireless communication system according to an embodiment of the disclosure;

FIG. 4 illustrates an example of configuration of a control resource set of a downlink control channel in a wireless communication system according to an embodiment of the disclosure;

FIG. 5 illustrates a structure of a downlink control channel in a wireless communication system according to an embodiment of the disclosure;

FIG. 6 is a diagram for explaining a method in which a base station and a UE transmit/receive data in consideration of a downlink data channel and a rate matching resource in a wireless communication system according to an embodiment of the disclosure;

FIG. 7 illustrates an example of frequency domain resource allocation with regard to a physical downlink shared channel (PDSCH) in a wireless communication system according to an embodiment of the disclosure;

FIG. 8 illustrates an example of time domain resource allocation with regard to a PDSCH in a wireless communication system according to an embodiment of the disclosure;

FIG. 9 illustrates an example of time domain resource allocation according to a subcarrier spacing with regard to a data channel and a control channel in a wireless communication system according to an embodiment of the disclosure;

FIG. 10 illustrates radio protocol structures of a base station and a UE in single cell, carrier aggregation, and dual connectivity situations according to an embodiment of the disclosure;

FIG. 11 illustrates an example in which a sounding reference signal (SRS) and a physical uplink shared channel (PUSCH) resource are allocated in units of resource blocks (RBs) or resource elements (REs) in a wireless communication system according to an embodiment of the disclosure;

FIG. 12 illustrates an example of a 5G and a 6G SRS resource allocation scheme according to an embodiment of the disclosure;

FIG. 13 illustrates an example of an RB switching SRS transmission structure in a slot in a 6G communication system according to an embodiment of the disclosure;

FIG. 14 illustrates an example of a parameter hierarchy used to configure a puncturing resource according to an embodiment of the disclosure;

FIG. 15 illustrates an example of a look-up table scheme according to an embodiment of the disclosure;

FIG. 16 illustrates an example of an SRS resource set configuration according to an embodiment of the disclosure;

FIG. 17 illustrates a series of signaling processes associated with a process of transmitting and receiving information about resource patterns between a base station and a terminal according to an embodiment of the disclosure;

FIG. 18 illustrates a process associated with a base station according to an embodiment of the disclosure;

FIG. 19 illustrates a process associated with a terminal according to an embodiment of the disclosure;

FIG. 20 illustrates a structure of a terminal in a wireless communication system according to an embodiment of the disclosure; and

FIG. 21 illustrates a structure of a base station in a wireless communication system according to an embodiment of the disclosure.

### DETAILED DESCRIPTION

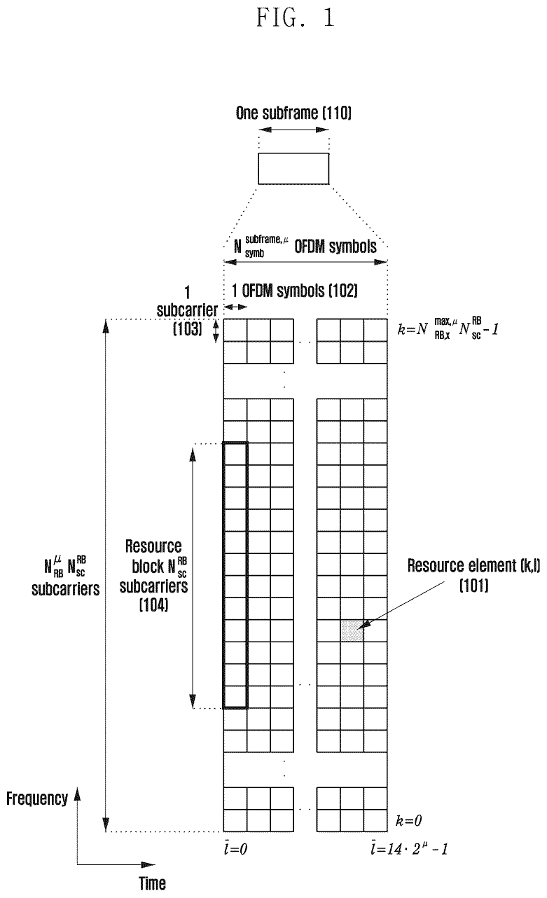

FIGS. 1 through 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted.

Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings.

However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more central processing units (CPUs) within a device or a security multimedia card.

In the following description, some of terms and names defined in the 3rd generation partnership project (3GPP) standards (standards for 5G, NR, LTE, or similar systems) may be used for the convenience of description. In addition, terms and names used in existing communication systems or newly defined in next-generation communication systems (e.g., 6G and beyond-5G systems) to which the disclosure is applicable may also be used. Use of these terms is not intended to limit the disclosure by the terms and names, and the disclosure may be applied in the same way to systems that conform other standards, and may be changed into other forms without departing from the technical idea of the disclosure. The embodiments of the disclosure may be easily applied to other communication systems through modifications.

As used here in, it will be understood that the singular expressions “a,” “an,” and “the” include plural expressions unless the context clearly indicates otherwise.

As used in an embodiment of the disclosure, the terms including an ordinal number, such as “a first” and “a second” may be used to described various elements, but the corresponding elements should not be limited by such terms. The above terms are used merely for the purpose of distinguishing one element from other elements. For example, a first element may be termed a second element, and similarly, a second element may be termed a first element without departing from the scope of protection of the disclosure.

As used in an embodiment of the disclosure, the term “and/or” includes any one or combinations of a plurality of relevant items enumerated.

The terms as used in an embodiment of the disclosure are merely used to describe specific embodiments, and are not intended to limit the disclosure. A singular expression may include a plural expression unless they are definitely different in a context. As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

As used in an embodiment of the disclosure, the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

As used in the disclosure, the expression “greater than” or “less than” is used to determine whether a specific condition is satisfied or fulfilled, but this is intended only to illustrate an example and does not exclude “greater than or equal to” or “equal to or less than.” A condition indicated by the expression “greater than or equal to” may be replaced with a condition indicated by “greater than,” a condition indicated by the expression “equal to or less than” may be replaced with a condition indicated by “less than,” and a condition indicated by “greater than and equal to or less than” may be replaced with a condition indicated by “greater than and less than.”

Furthermore, embodiments of the disclosure will be described using terms used in some communication standards (e.g., long term evolution (LTE) or new radio (NR) defined by the 3rd generation partnership project (3GPP)), but they are for illustrative purposes only. The embodiments of the disclosure may be easily applied to other communication systems through modifications.

Before the detailed description of the disclosure, examples of construable meanings of some terms used herein are given below. However, it should be noted that the terms are not limited to the examples of the construable meanings as given below.

In the disclosure, a terminal (or communication terminal) is an entity that communicates with a base station or any other terminal, and may be referred to as a node, a user equipment (UE), a next generation UE (NG UE), a mobile station (MS), a device, a terminal, or the like. The terminal may include at least one of a smartphone, a tablet personal computer (PC), a mobile phone, a video phone, an electronic book reader, a desktop PC, a laptop PC, a netbook computer, a personal digital assistant (PDA), a portable multimedia player (PMP), an MP3 player, a medical device, a camera, and a wearable device. Also, the terminal may include at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a media box, a game console, an electronic dictionary, an electronic key, a camcorder, and an electronic photo frame. In addition, the terminal may include at least one of various medical devices (e.g., various portable medical measuring devices (blood glucose monitoring device, heart rate monitoring device, blood pressure measuring device, body temperature measuring device, etc.), magnetic resonance angiography (MRA), magnetic resonance imaging (MRI), computed tomography (CT) machine, ultrasonic machine, etc.), a navigation device, a global positioning system (GPS) receiver, an event data recorder (EDR), a flight data recorder (FDR), a vehicle infotainment device, electronic equipment for a ship (e.g., ship navigation device, gyro-compass, etc.), avionics, a security device, an automobile head unit, a home or industrial robot, a drone, an automatic teller's machine (ATM) in banks, point of sales (POS) in a shop, or Internet of things devices (e.g., light bulb, various sensors, electric or gas meter, sprinkler device, fire alarm, thermostat, streetlamp, toaster, sporting goods, hot water tank, heater, boiler, etc.). Furthermore, the terminal may include various types of multimedia systems capable of communication functions. The disclosure is not limited by the above examples, and the terminal may also be referred to by terms having the same or similar meanings.

In the disclosure, a base station is an entity that communicates with terminals and allocates resources to the terminals, and may be referred to as a base station (BS), a Node B (NB), a next generation radio access network (NG RAN), an access point (AP), a transmission reception point (TRP), a wireless access unit, a base station controller, a node on a network, or the like. Alternatively, according to function split, the base station may be referred to as a central unit (CU) or a distributed unit (DU). However, the disclosure is not limited by the above examples, and the base station may also be referred to by terms having the same or similar meanings.

In the disclosure, the term “radio resource control (RRC) message” may be referred to as “high level information,” “high level message,” “high level signal,” “high level signaling,” “high layer signaling,” or “upper layer signaling,” and the disclosure is not limited by them and the term may also be referred to as any other term having the same or like meaning.

In the disclosure, the term “data” may be referred to as “user data,” “user plane (UP) data,” or “application data,” and may also be referred to as a term having the same or like meaning as a signal transmitted/received through a data radio bearer (DRB).

In the disclosure, a direction in which data is transmitted from a terminal may be referred to as “uplink,” and a direction in which data is transmitted to a terminal may be referred to as “downlink.” Accordingly, in the case of uplink transmission, a transmitter may refer to a terminal, and a receiver may refer to a base station or a specific network entity in a communication system. Alternatively, in the case of downlink transmission, a transmitter may refer to a base station or a specific network entity in a communication system, and a receiver may refer to a terminal.

### [NR Time-Frequency Resources]

Hereinafter, a frame structure of a 5G system will be described in more detail with reference to the accompanying drawings.

FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104.

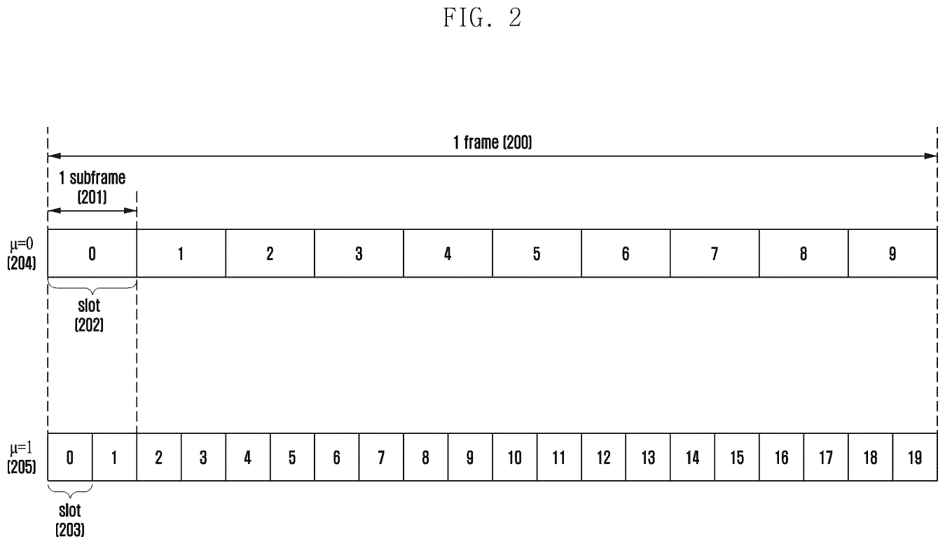

FIG. 2 illustrates a structure of a frame, a subframe, and a slot in a wireless communication system according to an embodiment of the disclosure.

FIG. 2 illustrates an example of a structure of a frame 200, a subframe 201, and a slot 202. One frame 200 may be defined as 10 ms. One subframe 201 may be defined as 1 millisecond (ms), and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values u for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe Nₛₗₒₜ^{sunframe,μ} may differ depending on the subcarrier spacing configuration value μ, and the number of slots per one frame Nₛₗₒₜ^{frame,μ} may differ accordingly. Nₛₗₒₜ^{sunframe,μ} and Nₛₗₒₜ^{frame,μ} may be defined according to each subcarrier spacing configuration u as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, bandwidth part (BWP) configuration in a 5G communication system will be described in detail with reference to the accompanying drawings.

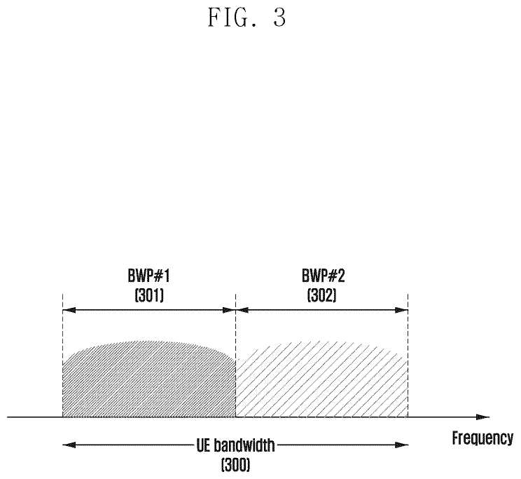

FIG. 3 illustrates an example of bandwidth part configuration in a wireless communication system according to an embodiment of the disclosure.

FIG. 3 illustrates an example in which a UE bandwidth 300 is configured to include two bandwidth parts, that is bandwidth part #1 (BWP #1) 301 and bandwidth part #2 (BWP #2) 302. A base station may configure one or multiple bandwidth parts for a UE, and may configure the following pieces of information with regard to each bandwidth part.

TABLE 2

| BWP ::= | SEQUENCE { |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, n2, |
| n3, n4, n5}, | |
| (subcarrier spacing) | |
| cyclicPrefix | ENUMERATED |

{ extended }
(cyclic prefix)
}

Obviously, the above example is not limiting, and various parameters related to the bandwidth part may be configured for the UE, in addition to the above configuration information. The above pieces of information may be transferred from the base station to the UE through upper layer signaling, for example, radio resource control (RRC) signaling. One configured bandwidth part or at least one bandwidth part among multiple configured bandwidth parts may be activated. Whether or not to activate a configured bandwidth part may be transferred from the base station to the UE semi-statically through RRC signaling, or dynamically through downlink control information (DCI).

According to some embodiment, the UE, prior to radio resource control (RRC) connection, may have an initial BWP for initial access configured by the base station through a master information block (MIB). To be more specific, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered as identity (ID) 0. The base station may notify the UE of configuration information, such as frequency allocation information, time allocation information, and numerology, regarding CORESET #0 through the MIB. In addition, the base station may notify the UE of configuration information regarding the monitoring cycle and occasion regarding control resource set #0, that is, configuration information regarding control resource set #0, through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to some embodiments, if the bandwidth supported by the UE is smaller than the system bandwidth, this may be supported through the bandwidth part configuration. For example, the base station may configure the frequency location of the bandwidth part for the UE, so that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing, and when data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth (for example, 100 MHz) and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through a master information block (MIB) in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may instruct to the UE to change (or switch) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given in Table 3 below, for example.

TABLE 3

| | NR Slot length | BWP switch delay T_{BWP} (slots) | |
|---|---|---|---|
| μ | (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. If the base station wants to schedule a data channel by using the new bandwidth part, the base station may determine time domain resource allocation regarding the data channel in consideration of the UE's bandwidth part change delay time (TBWP). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change may indicate a slot offset (K0 or K2) value smaller than the bandwidth part change delay time (TBWP).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (that is, the last symbol of slot n+K−1).

### [Ss/Pbch Block]

Next, synchronization signal (SS)/PBCH blocks in 5G will be described.

An SS/PBCH block may refer to a physical layer channel block including a primary SS (PSS), a secondary SS (SSS), and a PBCH. Details thereof are as follows.

PSS: a signal which becomes a reference of downlink time/frequency synchronization, and provides partial information of a cell ID.

SSS: becomes a reference of downlink time/frequency synchronization, and provides remaining cell ID information not provided by the PSS. Additionally, the SSS may serve as a reference signal for PBCH demodulation of a PBCH.

PBCH: provides essential system information necessary for the UE's data channel and control channel transmission/reception. The essential system information may include search space-related control information indicating a control channel's radio resource mapping information, scheduling control information regarding a separate data channel for transmitting system information, and the like.

SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and control resource set #0 is quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) is transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

According to an embodiment, the DCI may be subjected to channel coding and modulation processes and then transmitted through a physical downlink control channel (PDCCH) after a channel coding and modulation process. A cyclic redundancy check is attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI is not explicitly transmitted, but is transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling the PUSCH, and the CRC may be scrambled by a C-RNTI. DCI format 0_0 in which the CRC is scrambled by a C-RNTI may include the following pieces of information in Table 4 below, for example.

TABLE 4
Identifier for DCI formats-[1] bit

$\text{Frequency domain resource assignment-[} ⌈ {log}_{2} ( \frac{{N}_{RB}^{UL , BWP} ( {N}_{RB}^{UL , BWP} + 1 )}{2} ) ⌉ \text{Time domain resource assignment -} X \text{bits}$

Frequency hopping flag-1 bit.
Modulation and coding scheme-5 bits
New data indicator-1 bit
Redundancy version-2 bits
HARQ process number-4 bits
Transmit power control (TPC) command for scheduled PUSCH-[2] bits
Uplink/supplementary uplink (UL/SUL) indicator-0 or 1 bit

DCI format 0_1 may be used as non-fallback DCI for scheduling the PUSCH, and the CRC may be scrambled by a C-RNTI. DCI format 0_1 in which the CRC is scrambled by a C-RNTI may include the following pieces of information in Table 5 below, for example.

```
TABLE 5
  Carrier indicator-0 or 3 bits
  UL/SUL indicator-0 or 1 bit
  Identifier for DCI formats-[1] bits
  Bandwidth part indicator-0, 1 or 2 bits
  Frequency domain resource assignment
    $For resource allocation type 0 , ⌈ \frac{{N}_{RB}^{UL , BWP}}{P} ⌉ bits$
$\text{For resource allocation type 1,} ⌈ {log}_{2} ( \frac{{N}_{RB}^{UL , BWP} ( {N}_{RB}^{UL , BWP} + 1 )}{2} ) ⌉ \text{ime domain resource assignment-1, 2, 3, or 4 bits}$
  Virtual resource block (VRB)-to-physical resource block (PRB) mapping-0 or 1 bit,
only for resource allocation type 1.
    0 bit if only resource allocation type 0 is configured;
    1 bit otherwise.
  Frequency hopping flag-0 or 1 bit, only for resource allocation type 1.
    0 bit if only resource allocation type 0 is configured;
    1 bit otherwise.
  Modulation and coding scheme-5 bits
  New data indicator-1 bit
  Redundancy version-2 bits
  HARQ process number-4 bits
  1st downlink assignment index-1 or 2 bits
    1 bit for semi-static HARQ-ACK codebook;
    2 bits for dynamic HARQ-ACK codebook with single HARQ-ACK codebook.
  2nd downlink assignment index-0 or 2 bits
    2 bits for dynamic HARQ-ACK codebook with two HARQ-ACK sub-codebooks;
    0 bit otherwise.
  TPC command for scheduled PUSCH-2 bits
      SRS resource indicator-┌ [symbol] log [symbol] _2(Σ_(k = 1)\hat{ }(L_max) [symbol] (▪(N_“SRS”@k)))┐ or
    ┌ [symbol] log [symbol] _2(N_“SRS”)┐og [symbol] _2(Σ_(k = 1)\hat{ }(L_max) [symbol] (▪(N_“SRS”@k)))┐ for non-codebook based PUSCH
    transmission;
      ┌log₂(N_{SRS})┐ codebook based PUSCH transmission.
  Precoding information and number of layers-up to 6 bits
  Antenna ports-up to 5 bits
  SRS request-2 bits
  CSI request-0, 1, 2, 3, 4, 5, or 6 bits
  Code block group (CBG) transmission information-0, 2, 4, 6, or 8 bits
  Phase tracking reference signal (PTRS)-demodulation reference signal (DMRS) association-0 or 2 bits.
  beta offset indicator-0 or 2 bits
  DMRS sequence initialization-0 or 1 bit
```

DCI format 1_0 may be used as fallback DCI for scheduling the PDSCH, and the CRC may be scrambled by a C-RNTI. DCI format 1_0 in which the CRC is scrambled by a C-RNTI may include the following pieces of information in Table 6 below, for example.

TABLE 6
Identifier for DCI formats-[1] bit
$\text{Frequency domain resource assignment-[} ⌈ {log}_{2} ( \frac{{N}_{RB}^{DL , BWP} ( {N}_{RB}^{DL , BWP} + 1 )}{2} ) ⌉ \text{Time domain resource assignment-} X \text{bits}$
VRB-to-PRB mapping-1 bit.
Modulation and coding scheme-5 bits
New data indicator-1 bit
Redundancy version-2 bits
HARQ process number-4 bits
Downlink assignment index-2 bits
TPC command for scheduled PUCCH-[2] bits
Physical uplink control channel (PUCCH) resource indicator-3 bits
PDSCH-to-HARQ feedback timing indicator-[3] bits

DCI format 1_1 may be used as non-fallback DCI for scheduling the PDSCH, and the CRC may be scrambled by a C-RNTI. DCI format 1_1 in which the CRC is scrambled by a C-RNTI may include the following pieces of information in Table 7 below, for example.

```
TABLE 7
  Carrier indicator-0 or 3 bits
  Identifier for DCI formats-[1] bits
  Bandwidth part indicator-0, 1 or 2 bits
  Frequency domain resource assignment
$For resource allocation type 0 , ⌈ \frac{{N}_{RB}^{DL , BWP}}{P} ⌉ bits$
$\text{For resource allocation type 1,} ⌈ {log}_{2} ( \frac{{N}_{RB}^{DL , BWP} ( {N}_{RB}^{DL , BWP} + 1 )}{2} ) ⌉ \text{ime domain resource assignment-1, 2, 3, or 4 bits}$
  VRB-to-PRB mapping-0 or 1 bit, only for resource allocation type 1.
0 bit if only resource allocation type 0 is configured; 1 bit otherwise.
  Physical resource block (PRB) bundling size indicator-0 or 1 bit
  Rate matching indicator-0, 1, or 2 bits
  Zero power (ZP) channel state information (CSI)-reference signal (RS) trigger-0, 1, or 2 bits
For transport block 1:
  Modulation and coding scheme-5 bits
  New data indicator-1 bit
  Redundancy version-2 bits
For transport block 2:
  Modulation and coding scheme-5 bits
  New data indicator-1 bit
  Redundancy version-2 bits
  HARQ process number-4 bits
  Downlink assignment index-0 or 2 or 4 bits
  TPC command for scheduled PUCCH-2 bits
  PUCCH resource indicator-3 bits
  PDSCH-to-HARQ_feedback timing indicator-3 bits
  Antenna ports-4, 5 or 6 bits
  Transmission configuration indication-0 or 3 bits
  SRS request-2 bits
  Code block group (CBG) transmission information-0, 2, 4, 6, or 8 bits
  CBG flushing out information-0 or 1 bit
  DMRS sequence initialization-1 bit
```

### [PDCCH: CORESET, REG, CCE, and Search Space]

Hereinafter, a downlink control channel in a 5G communication system will be described in more detail with reference to the accompanying drawings.

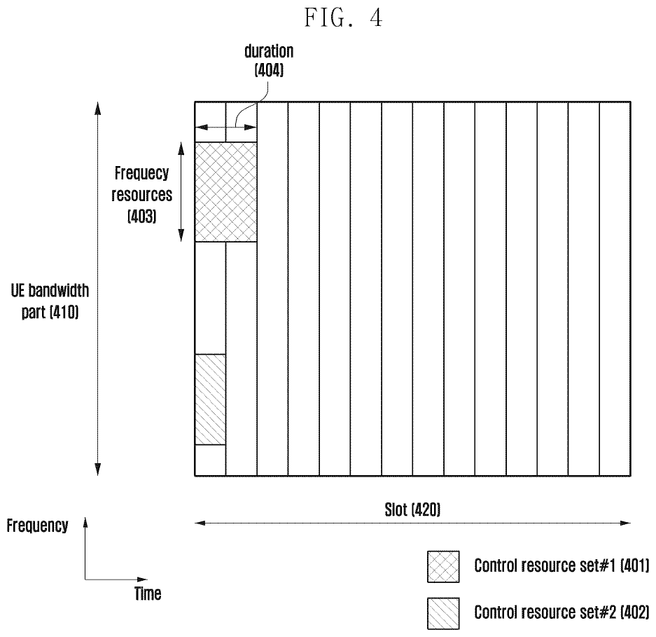

FIG. 4 illustrates an example of a control resource set (CORESET) used to transmit a downlink control channel in a 5G wireless communication system. FIG. 4 illustrates an example in which a UE bandwidth part 410 is configured along the frequency axis, and two control resource sets (control resource set #1 401 and control resource set #2 402) are configured within one slot 420 along the time axis. The control resource sets 401 and 402 may be configured in a specific frequency resource 410 within the entire UE bandwidth part 403 along the frequency axis. One or multiple OFDM symbols may be configured along the time axis, and this may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the control resource set may include the following pieces of information: given in Table 8 below.

TABLE 8

| | |
|---|---|
| ControlResourceSet ::= | SEQUENCE { |

```
      -- Corresponds to L1 parameter ‘CORESET-ID’
      controlResourceSetId
      ControlResourceSetId,
    (control resource set identity))
```

| | |
|---|---|
| frequencyDomainResources | BIT STRING (SIZE |

(45)),
(frequency domain resource allocation information)

| | |
|---|---|
| duration | INTEGER |

```
(1..maxCoReSetDuration),
    (time domain resource allocation information)
      cce-REG-MappingType
      CHOICE {
    (CCE-to-REG mapping type)
        interleaved
      SEQUENCE {
          reg-BundleSize
      ENUMERATED {n2, n3, n6},
      (REG bundle size)
          precoderGranularity
      ENUMERATED {sameAsREG-bundle, allContiguousRBs},
          interleaverSize
      ENUMERATED {n2, n3, n6}
          (interleaver size)
          shiftIndex
        INTEGER(0..maxNrofPhysicalResourceBlocks-1)
```

OPTIONAL

```
        (interleaver shift)
      },
```

| | |
|---|---|
| nonInterleaved | NULL |

```
      },
      tci-StatesPDCCH
      SEQUENCE(SIZE (1..maxNrofTCI-StatesPDCCH))
      OF TCI-StateId
          OPTIONAL,
    (QCL configuration information)
```

| | |
|---|---|
| tci-PresentInDCI | ENUMERATED |

{enabled}

OPTIONAL, -- Need S

}

In Table 8, tci-StatesPDCCH (simply referred to as transmission configuration indication (TCI) state) configuration information may include information of one or multiple synchronization signal (SS)/physical broadcast channel (PBCH) block index or channel state information reference signal (CSI-RS) index, which is quasi-co-located with a DMRS transmitted in a corresponding control resource set.

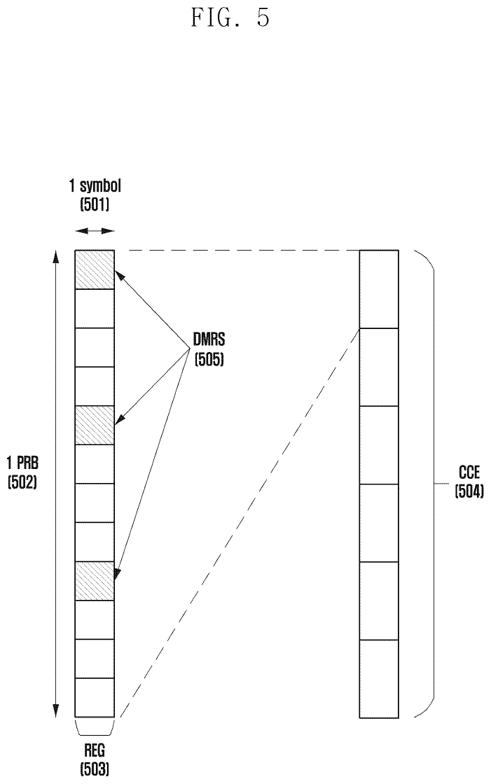

FIG. 5A illustrates an example of a basic unit of time and frequency resources constituting a downlink control channel available in 5G. According to FIG. 5, the basic unit of time and frequency resources constituting a control channel may be referred to as a resource element group (REG) 503, and the REG 503 may be defined by one OFDM symbol % n along the time axis and one physical resource block (PRB) 502 (that is, 12 subcarriers) along the frequency axis. The base station may configure a downlink control channel allocation unit by concatenating the REGs 503.

Provided that the basic unit of downlink control channel allocation in 5G is a control channel element 504 as illustrated in FIG. 5A, one CCE 504 may include multiple REGs 503. To describe the REG 503 illustrated in FIG. 5A, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while having no information regarding the downlink control channel, and a search space indicating a set of CCEs has thus been defined for blind decoding. The search space is a set of downlink control channel candidates including CCEs which the UE needs to attempt to decode at a given AL. Since 1, 2, 4, 8, or 16 CCEs constitute a bundle at various ALs, the UE may have multiple search spaces. A search space set may be defined as a set of search spaces at all configured ALs.

Search spaces may be classified into common search spaces and UE-specific search spaces. A group of UEs or all UEs may search a common search space of the PDCCH in order to receive cell-common control information such as a paging message or dynamic scheduling regarding system information. For example, PDSCH scheduling allocation information for transmitting an SIB including a cell operator information or the like may be received by searching the common search space of the PDCCH. In the case of a common search space, a group of UEs or all UEs need to receive the PDCCH, and the same may thus be defined as a pre-promised set of CCEs. Scheduling allocation information regarding a UE-specific PDSCH or PUSCH may be received by investigating the UE-specific search space of the PDCCH. The UE-specific search space may be defined UE-specifically as a function of various system parameters and the identity of the UE.

In 5G, a parameter regarding a search parameter regarding a PDCCH may be configured for the UE by the base station through upper layer signaling (for example, SIB, MIB, RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the control resource set may include the following pieces of information given in Table 9 below.

TABLE 9

| | |
|---|---|
| SearchSpace ::= | SEQUENCE { |

```
    -- Identity of the search space. SearchSpaceId = 0 identifies the SearchSpace
configured via PBCH (MIB) or ServingCellConfigCommon.
    searchSpaceId
    SearchSpaceId,
    (search space identity)
    controlResourceSetId
    ControlResourceSetId,
    (control resource set identity)
```

| | |
|---|---|
| monitoringSlotPeriodicityAndOffset | CHOICE { |

```
    (monitoring slot level perodicity)
      sl1
      NULL,
      sl2
      INTEGER (0..1),
      sl4
      INTEGER (0..3),
      sl5
    INTEGER (0..4),
      sl8
      INTEGER (0..7),
      sl10
    INTEGER (0..9),
      sl16
    INTEGER (0..15),
      sl20
    INTEGER (0..19)
    }
```

| | |
|---|---|
| | OPTIONAL, |
| duration(monitoring duration) | INTEGER (2..2559) |
| monitoringSymbolsWithinSlot | BIT |

STRING (SIZE (14))

OPTIONAL,

```
    (monitoring symbols within slot)
    nrofCandidates
    SEQUENCE {
    (number of PDCCH candidate groups for each aggregation level)
      aggregationLevel1
    ENUMERATED {n0, n1, n2, n3, n4, n5, n6, n8},
      aggregationLevel2
    ENUMERATED {n0, n1, n2, n3, n4, n5, n6, n8},
      aggregationLevel4
    ENUMERATED {n0, n1, n2, n3, n4, n5, n6, n8},
      aggregationLevel8
    ENUMERATED {n0, n1, n2, n3, n4, n5, n6, n8},
      aggregationLevel16
    ENUMERATED {n0, n1, n2, n3, n4, n5, n6, n8}
    },
```

| | |
|---|---|
| searchSpaceType | CHOICE { |

```
    (search space type)
      -- Configures this search space as common search space (CSS) and DCI
formats to monitor.
      common
    SEQUENCE {
    (common search space)
    }
      ue-Specific
    SEQUENCE {
    (UE-specific search space)
        -- Indicates whether the UE monitors in this USS for DCI formats
0-0 and 1-0 or for formats 0-1 and 1-1.
        formats
      ENUMERATED {formats0-0-And-1-0, formats0-1-And-1-1},
        ...
      }
```

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_01 with CRC scrambled by INT-RNTI;
DCI format 2_2 with CRC scrambled by TPC-PUSCH-RNTI, TPC-PUCCH-RNTI; and
DCI format 2_03 with CRC scrambled by TPC-SRS-RNTI.
Combinations of DCI formats and RNTIs given below may be monitored in a UE-specific search space. Obviously, the example given below is not limiting:
DCI format 0_0/1_0 with CRC scrambled by C-RNTI, CS-RNTI, TC-RNTI; and
DCI format 1_0/1_1 with CRC scrambled by C-RNTI, CS-RNTI, TC-RNTI.
Enumerated RNTIs may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step;
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI): used to indicate a power control command regarding a PUCCH; and
Transmit power control for SRS RNTI (TPC-SRS-RNTI): used to indicate a power control command regarding an SRS.

The DCI formats enumerated above may follow the definitions given in Table 10 below, for example.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, the search space at aggregation level L in connection with control resource set p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + iggregation level \qquad [ Equation 1 ]$$

$${n}_{CI} : carrier index \\ {N}_{CCE , p} : total number of CCEs existing in control resouces set p \\ {n}_{s , f}^{μ} : slot index \\ {M}_{s , max}^{( L )} of PDCCH candidates at aggregation level L \\ {m}_{s , {n}_{CI}} = 0 , … , {M}_{s , max}^{( L )} H candidate index at aggregation level L \\ i = 0 , … , L - 1 \\ {Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 , {A}_{p} = 39827 for p mod 3 = 0 , {A}_{p} = 39829 for p mod 3 = 1 , {A}_{p} = 39839 for p mod 3 = 2 , D = 65537 \\ {n}_{RNTI} : UE indentity .$$

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [Regarding Rate Matching/Puncturing]

Hereinafter, a rate matching operation and a puncturing operation will be described in detail.

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

### Rate Matching Operation

The base station may transmit channel A after mapping the same only to remaining resource domains other than resource C (area overlapping resource B) among the entire resource A which is to be used to transmit symbol sequence A to the UE. For example, assuming that symbol sequence A is configured as {symbol #1, symbol #2, symbol #3, symbol4}, resource A is {resource #1, resource #2, resource #3, resource #4}, and resource B is {resource #3, resource #5}, the base station may send symbol sequence A after successively mapping the same to remaining resources {resource #1, resource #2, resource #4} other than {resource #3} (corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A based on an assumption that symbol sequence A has been mapped and transmitted in the remaining area other than resource C among the entire resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, assuming that symbol sequence A is configured as {symbol #1, symbol #2, symbol #3, symbol4}, resource A is {resource #1, resource #2, resource #3, resource #4}, and resource B is {resource #3, resource #5}, the base station may map symbol sequence {symbol #1, symbol #2, symbol #3, symbol #4} to resource A {resource #1, resource #2, resource #3, resource #4}, respectively, may transmit only symbol sequence {symbol #1, symbol #2, symbol #4} corresponding to remaining resources {resource #1, resource #2, resource #4} other than {resource #3} (corresponding to resource C) among resource A, and may not transmit {symbol #3} mapped to {resource #3} (corresponding to resource C). Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A based on an assumption that symbol sequence A has been mapped to the entire resource A but transmitted only in the remaining area other than resource C among the resource area A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Hereinafter, a method for configuring a rate matching resource for the purpose of rate matching in a communication system will be described. Rate matching refers to adjusting the size of a signal in consideration of the amount of resources that can be used to transmit the signal. For example, data channel rate matching may mean that a data channel is not mapped and transmitted with regard to specific time and frequency resource domains, and the size of data is adjusted accordingly.

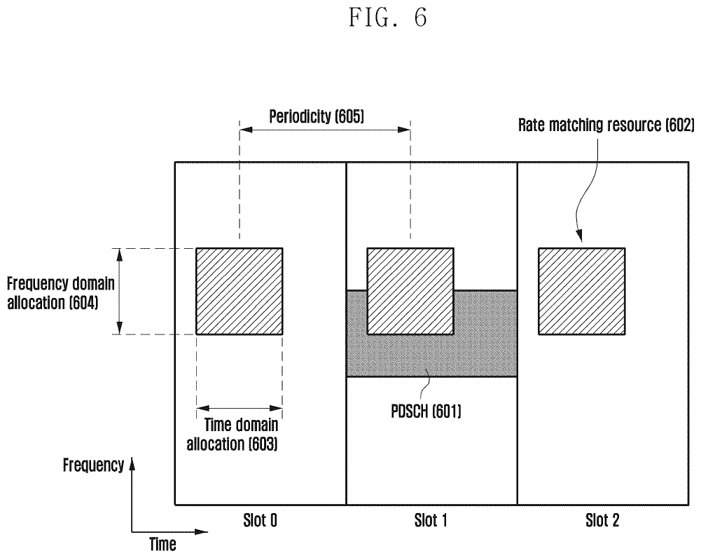

FIG. 6 illustrates a method in which a base station and a UE transmit/receive data in consideration of a downlink data channel and a rate matching resource in a wireless communication system according to an embodiment of the disclosure.

FIG. 6 illustrates a PDSCH 601 and a rate matching resource 602. The base station may configure one or multiple rate matching resources 602 for the UE through upper layer signaling (for example, RRC signaling). Rate matching resource 602 configuration information may include time-domain resource allocation information 603, frequency-domain resource allocation information 604, and periodicity information 605. A bitmap corresponding to the frequency-domain resource allocation information 604 will hereinafter be referred to as “first bitmap,” a bitmap corresponding to the time-domain resource allocation information 603 will be referred to as “second bitmap,” and a bitmap corresponding to the periodicity information 605 will be referred to as “third bitmap.” If all or some of time and frequency resources of the scheduled PDSCH 601 overlap a configured rate matching resource 602, the base station may rate-match and transmit the PDSCH 602 in a rate matching resource 601 part, and the UE may perform reception and decoding after assuming that the PDSCH 602 has been rate-matched in a rate matching resource 601 part.

The base station may dynamically notify the UE, through DCI, of whether the PDSCH may be rate-matched in the configured rate matching resource part through an additional configuration (corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, “1” may mean that rate matching is to be conducted, and “0” may mean that rate matching is not to be conducted.

As a method for configuring the above-described rate matching resources for a UE, granularity of “RB symbol level” and “RE level” is supported. More specifically, the following configuration method may be followed.

### RB Symbol Level

The UE may have a maximum of four RateMatchPatterns configured per each bandwidth part through upper layer signaling, and one RateMatchPattern may include the following contents.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. A time domain pattern (periodicity AndPattern) may be additionally configured wherein time and frequency domains including respective RB-level and symbol-level bitmap pairs are repeated.
may include a resource area corresponding to a time domain pattern configured by time and frequency domain resource areas configured by a control resource set inside a bandwidth part and a search space configuration in which corresponding resource areas are repeated.

### RE Level

The UE may have the following contents configured through upper layer signaling.
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

### [PDSCH: Regarding Frequency Resource Allocation]

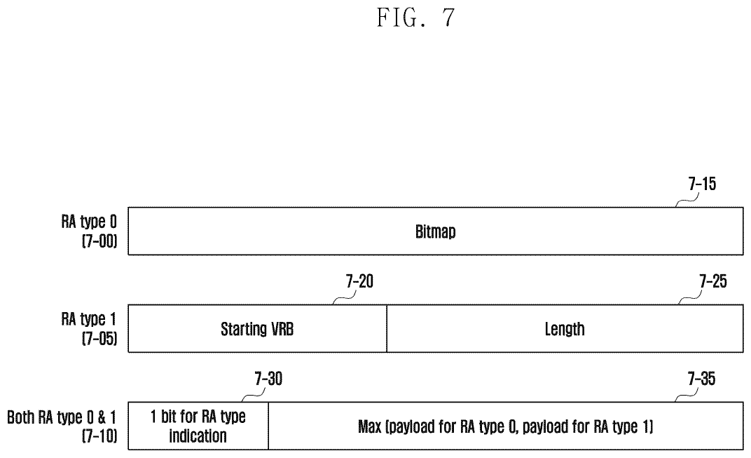

FIG. 7 illustrates an example of frequency domain resource allocation with regard to a physical downlink shared channel (PDSCH) in a wireless communication system according to an embodiment of the disclosure.

FIG. 7 illustrates three frequency domain resource allocation methods of type 0 7-00, type 1 7-05, and dynamic switch 7-10 which can be configured through an upper layer in an NR wireless communication system.

Referring to FIG. 7, in the case 7-00 in which a UE is configured to use only resource type 0 through upper layer signaling, partial downlink control information (DCI) for allocating a PDSCH to the UE include a bitmap including NRBG bits. The conditions for this will be described later. As used herein, NRBG refers to the number of resource block groups (RBGs) determined according to the BWP size allocated by a BWP indicator and upper layer parameter rbg-Size, as in Table 11 below, and data is transmitted in RBGs indicated as “1” by the bitmap.

TABLE 11

| Bandwidth part size | configuration 1 | configuration 2 |
|---|---|---|
| 1-36 | 2 | 4 |
| 37-72 | 4 | 8 |
| 73-144 | 8 | 16 |
| 145-275 | 16 | 16 |

In the case 7-05 in which the UE is configured to use only resource type 1 through upper layer signaling, partial DCI includes frequency domain resource allocation information including [log₂ (N_{RB}^{DL,BWP}(N_{RB}^{DL,BWP}+1)/2] bits. The conditions for this will be described again later. The base station may thereby configure a starting VRB 7-20 and the length 7-25 of a frequency domain resource allocated continuously therefrom.

In the case 7-10 in which the UE is configured to use both resource type 0 and resource type 1 through upper layer signaling, partial DCI for allocating a PDSCH to the corresponding UE includes frequency domain resource allocation information including as many bits as the larger value 7-35 between the payload 7-15 for configuring resource type 0 and the payload 7-20 and 7-25 for configuring resource type 1. The conditions for this will be described again later. One bit may be added to the foremost part (MSB) of the frequency domain resource allocation information inside the DCII, and if the bit has the value of “0,” use of resource type 0 may be indicated, and if the bit has the value of “1,” use of resource type 1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (corresponding to a slot-unit time interval between a timepoint at which a PDCCH is received and a timepoint at which a PDSCH scheduled by the received PDCCH is transmitted; labeled K0), PDCCH-to-PUSCH slot timing (corresponding to a slot-unit time interval between a timepoint at which a PDCCH is received and a timepoint at which a PUSCH scheduled by the received PDCCH is transmitted; labeled K2), information regarding the location and length of the start symbol by which a PDSCH or PUSCH is scheduled inside a slot, the mapping type of a PDSCH or PUSCH, and the like. For example, information such as in Table 12 or Table 13 below may be transmitted from the base station to the UE.

TABLE 12
PDSCH-TimeDomainResourceAllocationList information element

| | |
|---|---|
| PDSCH-TimeDomainResourceAllocationList | ::= SEQUENCE (SIZE(1..maxNrofDL- |

Allocations)) OF PDSCH-TimeDomainResourceAllocation
PDSCH-TimeDomainResourceAllocation ::= SEQUENCE {

| | |
|---|---|
| k0 INTEGER(0..32) | OPTIONAL, -- Need S |

(PDCCH-to-PDSCH timing, slot unit)

| | |
|---|---|
| mappingType (PDSCH mapping type) | ENUMERATED {typeA, typeB}, |
| startSymbolAndLength (start symbol and length of PDSCH) | INTEGER (0..127) |

}

TABLE 13
PUSCH-TimeDomainResourceAllocation information element

-- ASN1START
-- TAG-PUSCH-TIMEDOMAINRESOURCEALLOCATIONLIST-START

| | |
|---|---|
| PUSCH-TimeDomainResourceAllocationList | ::= SEQUENCE (SIZE(1..maxNrofUL- |

Allocations)) OF PUSCH-TimeDomainResourceAllocation
PUSCH-TimeDomainResourceAllocation ::= SEQUENCE {

| | |
|---|---|
| k2 INTEGER(0..32) | OPTIONAL, -- Need S |

(PDCCH-to-PUSCH timing, slot unit)

| | |
|---|---|
| mappingType (PUSCH mapping type) | ENUMERATED {typeA, typeB}, |
| startSymbolAndLength (start symbol and length of PUSCH) | INTEGER (0..127) |

}

The base station may notify the UE of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

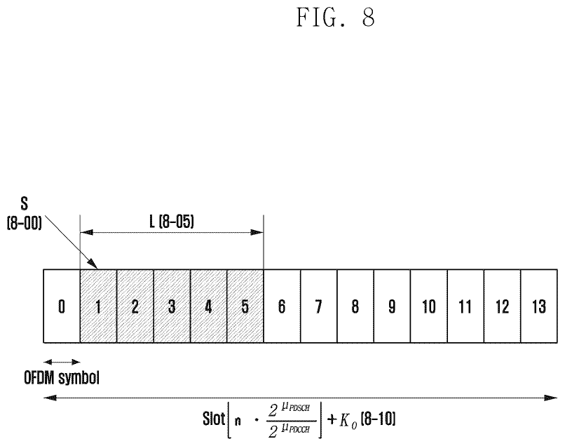

FIG. 8 illustrates an example of time domain resource allocation with regard to a PDSCH in a wireless communication system according to an embodiment of the disclosure.

Referring to FIG. 8, the UE may indicate the time domain location of a PDSCH resource according to the subcarrier spacing (SCS)(μ_{PDSCH}, μ_{PDCCH}) of a data channel and a control channel configured by using an upper layer, the scheduling offset (K0) value, and the OFDM symbol start location 8-00 and length 8-05 within one slot dynamically indicated through DCI.

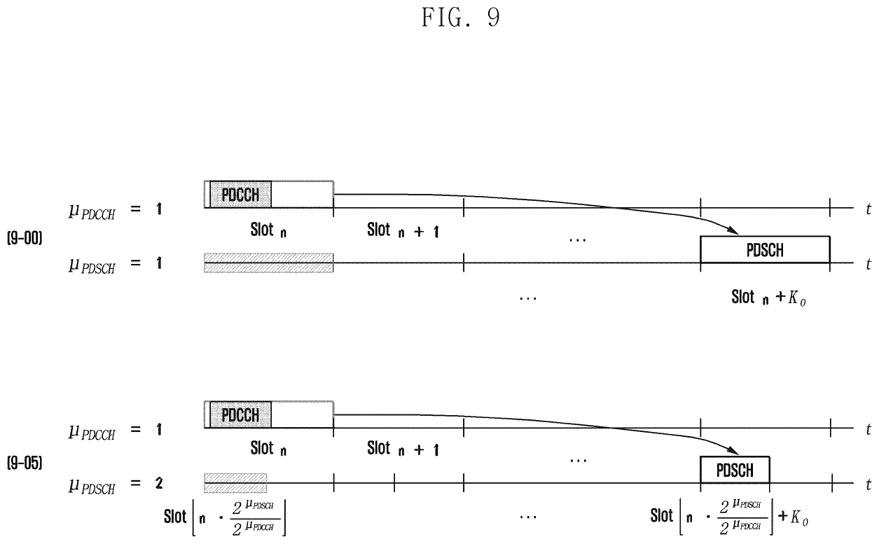

FIG. 9 illustrates an example of time domain resource allocation according to a subcarrier spacing with regard to a data channel and a control channel in a wireless communication system according to an embodiment of the disclosure.

Referring to FIG. 9, if the data channel and the control channel have the same subcarrier spacing 9-00 (μ_{PDSCH}=μ_{PDCCH}), the slot number for data and that for control are identical, and the base station and the UE may accordingly generate a scheduling offset in conformity with a predetermined slot offset K0. On the other hand, if the data channel and the control channel have different subcarrier spacings 9-05 (PDSCH≠μ_{PDCCH}), the slot number for data and that for control are different, and the base station and the UE may accordingly generate a scheduling offset in conformity with a predetermined slot offset K0 with reference to the subcarrier spacing of the PDCCH.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 14 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 14 through upper signaling. If PUSCH transmission is operated by a configured grant, parameters applied to the PUSCH transmission are applied through configuredGrantConfig (upper signaling) in Table 14 except for dataScramblingIdentityPUSCH, txConfig, codebookSubset, maxRank, and scaling of UCI-OnPUSCH, which are provided by pusch-Config (upper signaling) in Table 15. If provided with transformPrecoder inside configuredGrantConfig (upper signaling) in Table 14, the UE applies tp-pi2BPSK inside pusch-Config in Table 15 to PUSCH transmission operated by a configured grant.

TABLE 14

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | | |
|---|---|---|
| rbg-Size | ENUMERATED { config2} | OPTIONAL, -- |

Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |

```
        sym2, sym7, sym1x14, sym2x14, sym4x14, sym5x14, sym8x14,
sym10x14, sym16x14, sym20x14,
        sym32x14, sym40x14, sym64x14, sym80x14, sym128x14,
sym160x14, sym256x14, sym320x14, sym512x14,
        sym640x14, sym1024x14, sym1280x14, sym2560x14,
sym5120x14,
        sym6, sym1x12, sym2x12, sym4x12, sym5x12, sym8x12,
sym10x12, sym16x12, sym20x12, sym32x12,
        sym40x12, sym64x12, sym80x12, sym128x12, sym160x12,
sym256x12, sym320x12, sym512x12, sym640x12,
        sym1280x12, sym2560x12
    },
```

| | | |
|---|---|---|
| configuredGrantTimer | INTEGER (1..64) | OPTIONAL, -- |

Need R

| rrc-ConfiguredUplinkGrant | SEQUENCE { | |
|---|---|---|
| timeDomainOffset | INTEGER (0..5119), | |
| timeDomainAllocation | INTEGER (0..15), | |
| frequencyDomainAllocation | BIT STRING (SIZE(18)), | |
| antennaPort | INTEGER (0..31), | |
| dmrs-SeqInitialization | INTEGER (0..1) | OPTIONAL, -- |
| Need R | | |
| precodingAndNumberOfLayers | INTEGER (0..63), | |
| srs-ResourceIndicator | INTEGER (0..15) | OPTIONAL, -- |

Need R

| | |
|---|---|
| mcsAndTBS | INTEGER (0..31), |
| frequencyHoppingOffset | INTEGER (1..maxNrofPhysicalResourceBlocks- |

1) OPTIONAL, -- Need

| | |
|---|---|
| pathlossReferenceIndex | INTEGER (0..maxNrofPUSCH- |

PathlossReferenceRSs-1),
...

| | |
|---|---|
| } | OPTIONAL, -- Need R |

```
    ...
  }
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 15, which is upper signaling, is “codebook” or “nonCodebook.”

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE perform beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 15, the UE does not expect scheduling through DCI format 0_1.

TABLE 15

| | |
|---|---|
| PUSCH-Config ::= | SEQUENCE { |

| | | |
|---|---|---|
| dataScramblingIdentityPUSCH | INTEGER (0..1023) | OPTIONAL, |

-- Need S

| | | |
|---|---|---|
| txConfig | ENUMERATED | {codebook, nonCodebook} |

OPTIONAL, -- Need S

| dmrs-UplinkForPUSCH-MappingTypeA | | SetupRelease { DMRS- |
|---|---|---|
| UplinkConfig } | OPTIONAL, -- Need M | |
| dmrs-UplinkForPUSCH-MappingTypeB | | SetupRelease { DMRS- |
| UplinkConfig } | OPTIONAL, -- Need M | |
| pusch-PowerControl | PUSCH-PowerControl | OPTIONAL, - |

- Need M

| | | |
|---|---|---|
| frequencyHopping | ENUMERATED | {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)

| | OPTIONAL, -- Need M | |
|---|---|---|
| resource Allocation | ENUMERATED | { resourceAllocationType0, |

resourceAllocationType1, dynamicSwitch},

| | |
|---|---|
| pusch-TimeDomainAllocationList | SetupRelease { PUSCH- |

| | |
|---|---|
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent,nonCoherent}

| | OPTIONAL, -- Cond codebookBased | |
|---|---|---|
| maxRank | INTEGER (1..4) | OPTIONAL, -- Cond |

codebookBased

| | | |
|---|---|---|
| rbg-Size | ENUMERATED { config2} | OPTIONAL, -- Need |

S

| | | |
|---|---|---|
| uci-OnPUSCH | SetupRelease { UCI-OnPUSCH} | OPTIONAL, |

-- Need M

| | | |
|---|---|---|
| tp-pi2BPSK | ENUMERATED {enabled} | OPTIONAL, -- Need |

```
S
    ...
  }
```

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determine a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. Similar to the above-described codebook-based PUSCH transmission, if the UE is provided with the SRI through DCI, the SRS resource indicated by the corresponding SRI may refer to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder applied to PUSCH transmission. If one SRS resource is configured for the UE, the TPMI may be used to indicate a precoder to be applied in the configured SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fully AndPartial AndNonCoherent,” “partialAndNonCoherent,” or “noncoherent,” based on UE capability reported by the UE to the base station. In addition, if the UE reported “nonCoherent” as UE capability, UE does not expect that the value of codebookSubset (upper signaling) may be configured as “fully AndPartialAndNonCoherent” or “partialAndNonCoherent.” In addition, if the UE reported “nonCoherent” as UE capability, UE does not expect that the value of codebookSubset (upper signaling) may be configured as “fully AndPartialAndNonCoherent” or “partial AndNonCoherent.” If nrofSRS-Ports inside SRS-ResourceSet (upper signaling) indicates two SRS antenna ports, UE may not expect that the value of codebookSubset (upper signaling) may be configured as “partial AndNonCoherent.”

The UE may have one SRS resource set configured therefor, wherein the value of usage inside SRS-ResourceSet (upper signaling) is “codebook,” and one SRS resource may be indicated through an SRI inside the SRS resource set. If multiple SRS resources are configured inside the SRS resource set wherein the value of usage inside SRS-ResourceSet (upper signaling) is “codebook,” the UE may expect that the value of nrofSRS-Ports inside SRS-Resource (upper signaling) is identical with regard to all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. By using the SRS resource indicated by the SRI, the UE may apply the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook,” non-codebook-based PUSCH transmission may be scheduled for the UE through DCI format 0_1.

With regard to the SRS resource set wherein the value of usage inside SRS-ResourceSet (upper signaling) is “nonCodebook,” one connected NZP CSI-RS resource (non-zero power CSI-RS) may be configured for the UE. The UE may calculate a precoder for SRS transmission by measuring the NZP CSI-RS resource connected to the SRS resource set. For example, if the difference between the last received symbol of an aperiodic NZP CSI-RS resource associated with the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (upper signaling) is “aperiodic,” the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00.” The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associated CSI-RS inside SRS-ResourceSet (upper signaling). With regard to non-codebook-based transmission, the UE does not expect that spatialRelationInfo which is upper signaling regarding the SRS resource and associated CSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similar to the above-described codebook-based PUSCH transmission, if the UE is provided with the SRI through DCI, the SRS resource indicated by the corresponding SRI may refer to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook,” and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook,” and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### [Regarding CA/DC]

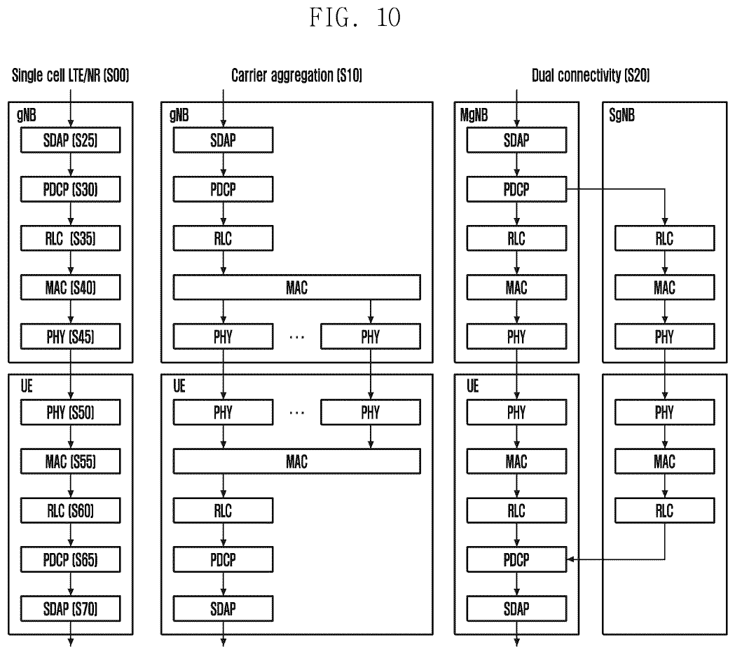

FIG. 10 illustrates radio protocol structures of a base station and a UE in single cell, carrier aggregation, and dual connectivity situations according to an embodiment of the disclosure.

Referring to FIG. 10, the radio protocol of a next-generation mobile communication system includes an NR service data adaptation protocol (SDAP) S25 or S70, an NR packet data convergence protocol (PDCP) S30 or S65, an NR radio link control (RLC) S35 or S60, and an NR medium access controls (MAC) S40 or S55, on each of UE and NR base station sides.

The main functions of the NR SDAP S25 or S70 may include some of functions below:
Transfer of user plane data;
Mapping between a QoS flow and a DRB for both DL and UL;
Marking QoS flow ID in both DL and UL packets; and
Reflective QoS flow to DRB mapping for the UL SDAP PDUs.

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP S30 or S65 may include some of functions below:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and
Timer-based SDU discard in uplink.

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC S35 or S60 may include some of functions below:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and
RLC re-establishment.

The above-mentioned in-sequence delivery of the NR RLC device refers to a function of successively delivering RLC SDUs received from the lower layer to the upper layer. The in-sequence delivery of the NR RLC device may include a function of reassembling and delivering multiple RLC SDUs received, into which one original RLC SDU has been segmented, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery function of the NR RLC device 1835 or 1860 may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MACs S40 and S55 may be connected to multiple NR RLC layer devices configured in one UE, and major functions of the NR MACs may include some of the following functions:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and
Padding.

The NR PHY layers S45 and S50 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. As an example, assuming that the base station transmits data to the UE based on a single carrier (or cell), the base station and the UE use a protocol structure having a single structure with regard to each layer, such as S00. On the other hand, assuming that the base station transmits data to the UE based on carrier aggregation (CA) which uses multiple carriers in a single TRP, the base station and the UE may use a protocol structure which has a single structure up to the RLC, such as S10, but multiplexes the PHY layer through a MAC layer. As another example, assuming that the base station transmits data to the UE based on dual connectivity (DC) which uses multiple carriers in multiple TRPs, the base station and the UE use a protocol structure which has a single structure up to the RLC, such as S20, but multiplexes the PHY layer through a MAC layer.

Hereinafter, the above examples may be described through multiple embodiments, but they are not independent of each other, and one or more embodiments may be applied simultaneously or in combination.

Hereinafter, embodiments of the disclosure will be described in detail in conjunction with the accompanying drawings. In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description, embodiments of the disclosure will be described in connection with 5G systems by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure. The contents of the disclosure may be applied to FDD and TDD systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); and
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and
Uplink control information (UCI).

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through multiple embodiments, but they are not independent of each other, and one or more embodiments may be applied simultaneously or in combination.

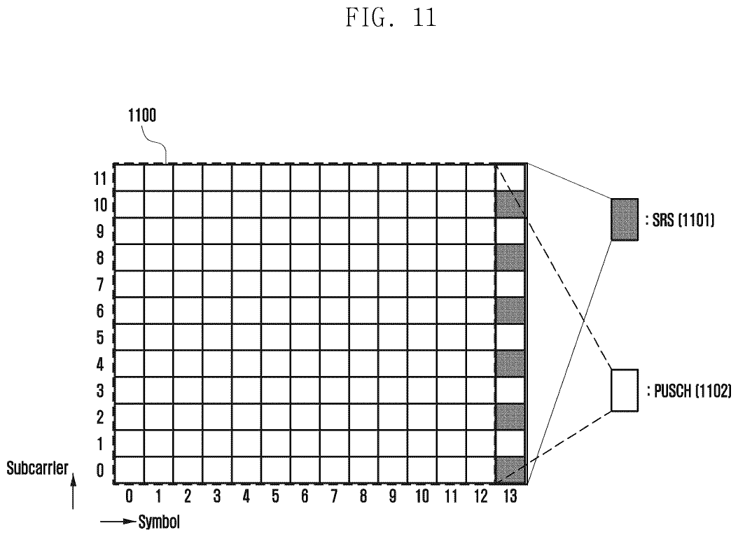

FIG. 11 illustrates an example in which a sounding reference signal (SRS) and a physical uplink shared channel (PUSCH) resource are allocated in units of resource blocks (RBs) or resource elements (REs) in a wireless communication system according to an embodiment of the disclosure.

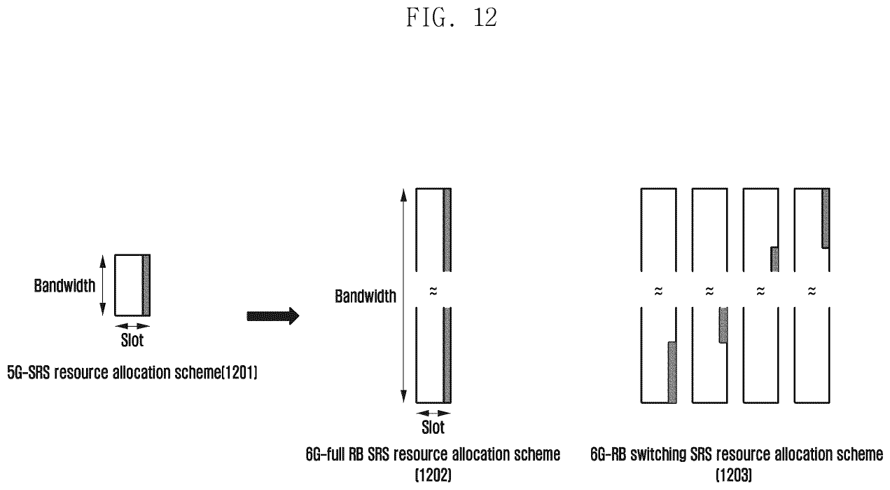

FIG. 12 illustrates an example of a 5G and a 6G SRS resource allocation scheme according to an embodiment of the disclosure.

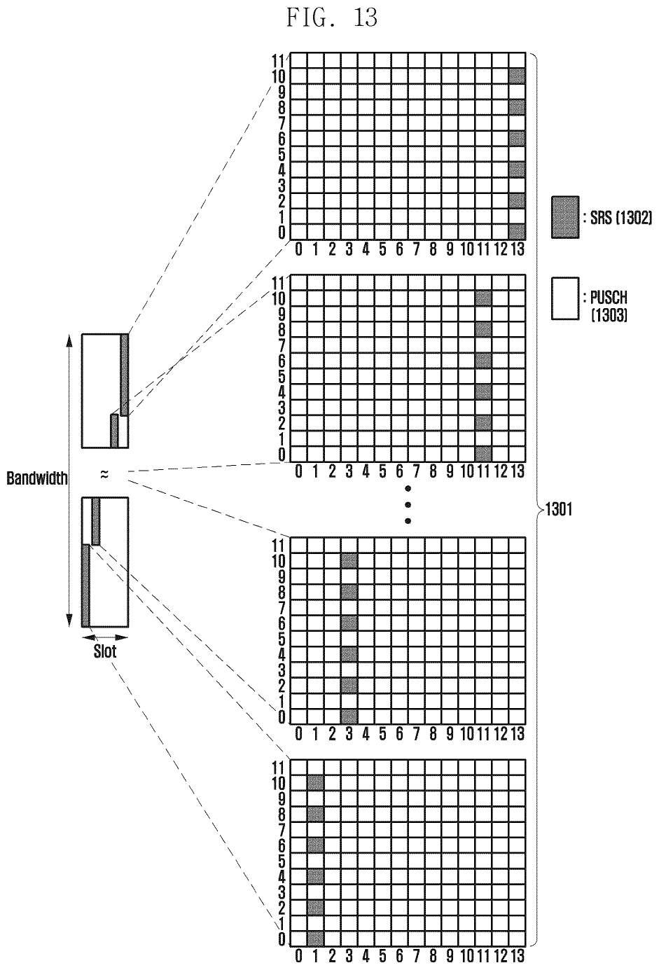

FIG. 13 illustrates an example of an RB switching SRS transmission structure in a slot in a 6G communication system according to an embodiment of the disclosure.

An embodiment of the disclosure provides a resource element puncturing technique and a method for configuring a related resource pattern in order to overcome a case in which PUSCH resource allocation is unable to be indicated using a conventional PUSCH resource allocation technique during SRS resource allocation in a 6G communication system.

According to an embodiment, an upper-mid band may be considered as a 6G frequency band and, in this case, a lower energy per resource element (EPRE) for an uplink signal/channel may be expected compared to a conventional mid-band 5G NR system. This is because, firstly, output power of a predetermined level or higher is unable to be used due to health hazard issues, and secondly, as the center frequency increases in 6G systems, the available bandwidth also increases. At the same time, as the center frequency increases, the degree of signal path attenuation (pathloss) becomes more severe, and the received uplink signal-to-interference-plus-noise ratio (SINR) may be expected to be further deteriorated. On the other hand, an SRS is primarily used to estimate an uplink channel, and a transmit antenna switching (TAS) scheme, in which a terminal performs transmission by switching a transmission antenna, is a very important SRS usage that can estimate a full channel matrix of transmission and reception nodes and is considered as one of the key element technologies for 5G beamforming technology. Although the importance of SRS may be expected to grow even more in 6G, if it is based on a time division duplexing (TDD) system, SRS performance degradation is inevitable due to the above-mentioned uplink performance degradation factors.

Referring to FIG. 11, in relation to an embodiment for solving the above problems, an example of a scheme in which SRS resources 1101 and PUSCH resources 1102 are allocated to an RB 1100 is illustrated.

In relation to a scheme in which resources are allocated in FIG. 11, a value may be defined for the shape or pattern of resources being allocated evenly or unevenly spaced in a frequency or time domain.

Further, the value may include an offset value, a cyclic shift, or a cyclic shift value of a resource allocation position in the frequency domain.

For example, transmissionComb in Table 19 may be one example of the above value. As shown in Table 19, a Comb value (transmissionComb value) may be configured by n2 or n4, and each Comb value may include information about a cyclic shift and a resource allocation position offset in a domain.

For example, a subcarrier spacing or a pattern allocated in units of REs in the frequency domain may differ according to a Comb value.

For example, the Comb value may indicate a spacing between subcarriers that are allocated in the frequency domain.

For example, in FIG. 11, a resource allocation to an RB may correspond to a case of Comb value n2 and may be exemplified such that SRS resources are allocated to one RE for every two subcarriers.

For example, nrofSymbol in Table 19 may be one example of the above value.

The nrofSymbol n may refer to the length of a symbol allocated in the time domain. Accordingly, FIG. 11 may exemplify that the resource allocation in RBs corresponds to Comb n2 and nrofSymbol n1.

For example, in FIG. 11, the SRS 1101 is allocated in a 13th symbol in full RBs, and it may be seen that the SRS 1101 is allocated in units of REs every two subcarrier spacings.

For example, the PUSCH 1102 or other resources may be allocated to a part excluding REs to which the SRS 1101 is allocated.

Further, an SRS resource allocation method as illustrated in FIG. 12 may be considered.

Referring to FIG. 12, an SRS allocation scheme 1201 commonly used in a 5G communication system may correspond to a scheme of allocating SRS resources to a predetermined symbol across a full bandwidth.

In case of using a full RB SRS resource allocation scheme 1202, which is exemplified by using the same scheme of allocating SRS resources across the full bandwidth in a 6G communication system, the received SINR of the SRS rapidly decreases due to lower EPRE and higher pathloss.

According to an embodiment disclosed in order to overcome this problem, an SRS resource allocation scheme 1203, such as in the form of RB switching SRS, may be considered. According to this scheme, SRS resources are divided and allocated to two or more transmitted slots rather than a single slot. However, this scheme may be problematic in that a logical periodicity required to obtain full channel matrix information, i.e., a periodicity for reception of the full channel matrix information increases, and thus old channel information and new channel information may mixedly exist.

In conclusion, use of the full RB SRS resource allocation scheme 1202 is disadvantageous in that the EPRE may lowered, and use of the RB switching SRS resource allocation scheme 1203 is disadvantageous in that the logical periodicity may increase. Factors increasing the logical periodicity may include necessity for bandwidth-specific switching for SRS transmission in order to increase EPRE, and switching for changing of transmission antennas for SRS transmission.

In relation to an embodiment to compensate for the above disadvantages, a case may be considered in which the number of SRS transmissions required to obtain the full channel matrix information may increase significantly due to a wider bandwidth and increased number of reception antennas in a 6G communication system, compared to a 5G communication system.

In this case, instead of transmitting an SRS in every slot, a method is disclosed in the form of transmitting an SRS multiple times in a slot, as shown in FIG. 13.

FIG. 13 illustrates an RB switching SRS resource allocation scheme in one slot, and here, a slot 1300 corresponds to an example of a slot that may be considered in a 6G communication system, compared to the 5G communication system.

RBs 1301 to which SRS resources included in a slot exemplified in FIG. 13 are allocated correspond to one example, and other combinations (or patterns) may be possible. Further, the number of RBs and the like are not limited, and FIG. 13 corresponds to one example.

An SRS 1302 disclosed in FIG. 13 may correspond to REs allocated within an RB according to SRS configuration information or full RBs, and a PUSCH 1303 may be allocated to parts (REs or RBs), excluding parts to which SRS resources 1302 are allocated.

In relation to the RB 1301 disclosed in FIG. 13, the allocation of the SRS 1302 according to Comb n2 and nrofSymbol n1 is shown. Further, in order, from top to bottom, in the illustrated multiple RBs 1301, it is illustrated that the SRS 1302 is assigned to Comb n2 and nrofSymbol n1 in symbol #13 in an RB associated with a first frequency band, that the SRS 1302 is assigned to Comb n2 and nrofSymbol n1 in symbol #11 in an RB associated with a second frequency band, that the SRS 1302 is assigned to Comb n2 and nrofSymbol n1 in symbol #3 in an RB associated with a n-th frequency band, and that the SRS 1302 is assigned to Comb n2 and nrofSymbol n1 in symbol #1 in an RB associated with a (n+1) th frequency band.

In relation to the above example, the positions of RBs including SRS resource allocation for each frequency band, the positions of a symbol to which SRS resources are allocated, or a pattern of the allocated REs may change.

As another example associated with the RB 1301 exemplified in FIG. 13, the exemplified multiple RBs 1301 may be configured in an order in which different rules are applied (e.g., the position or order of symbols to which SRS is allocated may be the reverse of that shown in FIG. 13).

As another example associated with the RBs 1301 exemplified in FIG. 13, the multiple RBs 1301 illustrated in sequence may be configured randomly or regardless of a predetermined bandwidth location rather than being arranged with a specific rule.

As another example associated with the RBs 1301 exemplified in FIG. 13, the number of REs to which SRSs are allocated may be changed by changing the value of Comb or nrofSymbol, such as changing to Comb n3 or nrofSymbol n1.

The above examples may be applied independently or simultaneously, and thus the pattern of resources being allocated in relation to an embodiment may be obtained in various combinations.

That is, it may be appreciated that there are myriad combinations of patterns of SRS being allocated, according to the positions of RBs or REs to which SRSs are allocated.

In the embodiments described herein, the SRS may be replaced by any other reference signal (RS) and is not limited to the SRS. For ease of explanation, although the RS will be described as an SRS for illustrative purposes, the embodiments of the disclosure may be similarly applied by replacing the SRS by a predetermined other RS.

In relation to a related embodiment, a method of indicating, to a terminal, allocated resources through a UL grant in a 5G specification is disclosed.

Specifically, a time domain resource allocation (TDRA) and a frequency domain resource allocation (FDRA) are configured. TDRA represents resource allocation on a time axis and, more specifically, information about a start symbol and length (SLIV) for a PUSCH, uplink DMRS pattern information associated with an unallocated RE, etc. may be transferred. FDRA represents resource allocation on a frequency axis and, more specifically, information about a start RB and length (resource indicator value (RIV)) for a PUSCH, bitmap related information, etc. are transferred.

In relation to an embodiment with respect to FIG. 13, when the communication system preforms resource allocation for SRS in the RB switching SRS structure in a single slot of FIG. 13, there may be no method in which a terminal is able to indicate, to a PUSCH, allocating the remaining resources after allocation to a single terminal, based on the 5G standard currently in use as described above.

Specifically, according to the method described above, the terminal is unable to be indicated to perform PUSCH resource allocation, excluding SRS resources allocated in different symbol positions for each RB index, as shown in FIG. 13.

Therefore, in order to solve the above problem, an embodiment of the disclosure provides a method capable of indicating allocation of PUSCH resources without overlapping SRS or other reference signals when they are allocated in different symbol positions and physical resource block (PRB) positions in one slot.

Further, an embodiment of the disclosure provides a method capable of indicating PUSCH resource allocation in units of REs, excluding SRS resources that are allocated in units of REs.

Further, in relation to the foregoing, since there are a myriad of combinations of resource patterns when a resource allocation structure such as FIG. 13 is applied, and it is disadvantageous for the terminal to support them in real time in terms of various efficiency aspects, such as transmission overload problems, the disclosure provides a method of simplifying a process of uplink resource allocation by pre-configuring primary resource patterns used in practice.

The above resource patterns will be described in detail.

A resource pattern is a pattern obtained by puncturing SRS (or RS) resources that are allocated in units of RBs or REs in a slot.

Specifically, the resource pattern corresponds to patterns of resource block (RB) units or resource element (RE) units, obtained by puncturing a part in which SRS transmissions may overlap PUSCH allocations to avoid overlap, collision, or interference in advance.

In the disclosure below, a resource pattern may be described as a puncturing pattern, an RE puncturing pattern, a rate match pattern, or another similar pattern.

Further, a resource pattern according to an embodiment may include multiple parameters associated with a resource pattern, such as period information of a pattern associated with puncturing, time axis resource allocation information, frequency axis resource allocation information, or timing offset values, and combinations thereof.

Further, the information about the puncturing to be configured in association with the resource pattern may be exemplified or described as a puncturing resource.

Further, the configuration associated with the resource pattern may be configured by patterns of RE units.

Further, according to an embodiment in association with a resource pattern, the information associated with the resource pattern may be configured by a bitmap or a bit sequence.

A terminal for receiving SRS allocation and a terminal for receiving PUSCH allocation may be different terminals.

A terminal for receiving SRS allocation and a terminal for receiving PUSCH allocation may be the same terminal.

In an embodiment of the disclosure, a base station predefines (or establishes) one or more resource patterns that are primarily used in practice.

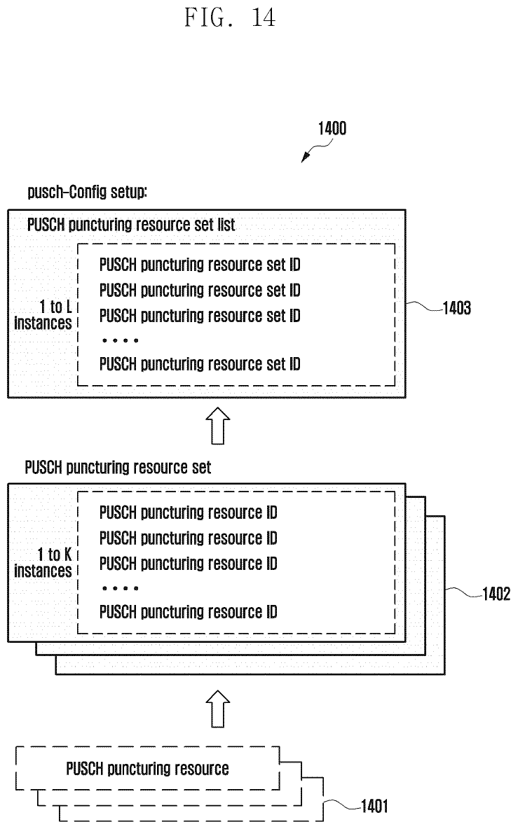

FIG. 14 illustrates a parameter hierarchy by defining a resource pattern as an identifier (ID) through an RRC message and exemplifying a list including IDs and sub-configurations thereof. In the following, embodiments related to FIG. 14 will be discussed in detail.

According to an embodiment of the disclosure, a base station defines a resource pattern as an identifier (ID) through an RRC message and transmits a list of one or more IDs to a terminal. Specifically, FIG. 14 illustrates one or more puncturing resources 1401. The puncturing resource 1401 may be defined by parameters associated with a resource pattern (e.g., a puncturing pattern). Specific examples may be defined in Table 16 below.

TABLE 16

| Parameter | Definition |
|---|---|
| startSymbolAndLengthForPuncturing | Indexes about start symbol and length associated with a |
| (=SLIV for puncturing) | combination of patterns with respect to the time axis of a |
| | slot. However, allocation is configured not to exceed slot |
| | boundaries. |
| startPrbAndLengthForPuncturing | Indexes about start PRB and length associated with a |
| (=RIV for puncturing) | combination of patterns with respect to the frequency axis |
| | of a slot. |
| transmissionCombForPuncturing | This parameter indicates Comb value and Comb offset |
| | value (0 . . . combValue − 1). |

The name of each parameter in Table 16 above may be referenced as an example associated with a resource pattern.

For example, the parameters for indicating the above pattern may be included as information for configuring an uplink resource of an RRC message. For example, the RRC message may correspond to an RRC message associated with setup of an RRC connection (e.g., an RRC setup message), or may correspond to an RRC message associated with reconfiguration of an RRC connection (e.g., an RRC reconfiguration message).

Further, the information for configuring the uplink resource may be information for configuring a PUSCH resource.

For example, the information for configuring the PUSCH resource may include at least one of PUSCH configuration information (e.g., PUSCH-config IE) for a particular terminal applicable to a particular BWP or PUSCH configuration information (e.g., PUSCH-configCommon IE) commonly applied to the terminals in a particular cell.

Further, the information for configuring the uplink resource may include information associated with frequency band configuration (e.g., BWP uplink configuration information).

For example, the information associated with the frequency band configuration may be information for an additional uplink BWP configuration (e.g., BWP-Uplink IE) rather than the initial BWP.

For example, the information associated with the frequency band configuration may include at least one of information for an uplink BWP configuration (e.g., BWP-UplinkCommon IE) that is commonly applied to a particular cell or information for an uplink BWP configuration (e.g., BWP-UplinkDedicated IE) that is applied to a particular terminal. The information associated with the frequency band configuration may include information associated with the position of the BWP on the frequency axis and information on a bandwidth, a subcarrier spacing, and a cyclic prefix.

Further, the information for configuring uplink resources may be included in the information configured for a terminal in relation to a serving cell (e.g., ServingCellConfig IE).

Further, the information configured for the terminal in relation to the serving cell may be included in the information for configuring a cell group (e.g., a master cell group (MCG) or secondary cell group (SCG)) (e.g., CellGroupConfig IE).

Further, the information for configuring the cell group may be included in an RRC message associated with setup of an RRC connection (e.g., an RRC setup message) or an RRC message associated with reconfiguration of an RRC connection (e.g., an RRC reconfiguration message).

Alternatively, the parameter may be defined and included as a new IE in the RRC message.

In relation to an embodiment associated with Table 16 above, the names defined in association with the above 3GPP parameters (e.g., startSymbolAndLength, startPrbAndLength, transmission Comb) may be modified and used as parameter names (e.g., startSymbolAndLengthForPuncturing, startPrbAndLengthForPuncturing, transmission CombForPuncturing) as exemplified in Table 16.

Next, respective sets 1402 may be defined as a combination of the puncturing resources 1401 defined above.

The respective sets 1402 may include a combination of multiple puncturing resources 1401, and the combination may include information about a resource pattern (e.g., a puncturing pattern).

The puncturing resources 1401 belonging to respective sets 1402 may be defined by identifiers (IDs), respectively. In relation to an embodiment, in FIG. 14, “K” may refer to a maximum number of puncturing resource IDs included in one set.

Next, one or more sets 1402 configured by the above-defined combination of puncturing resources 1401 may each be defined by an identifier (ID), and a puncturing resource set list 1403 configured by the IDs of the multiple sets 1402 may be defined.

In relation to an embodiment, “L” in FIG. 14 may refer to a maximum number of IDs of the multiple sets 1402.

According to an embodiment, the above defined configuration may be defined or configure for the terminal through an RRC message.

The above-defined puncturing resources 1401, the respective sets 1402 configured by a combination of the puncturing resources 1401, the puncturing resource set list 1403 configured by the IDs of the multiple sets 1402, and other names such as “K” and “L” are exemplary of this embodiment, and may be replaced by other relevant names and are not limited to the above definitions.

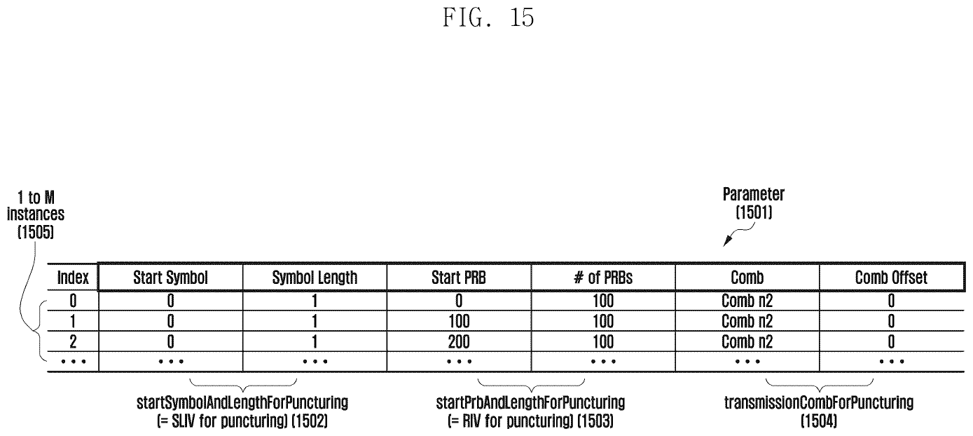

FIG. 15 illustrates an embodiment of a lookup table that may be pre-configured for a terminal. Hereinafter, embodiments related to FIG. 15 will be discussed in detail.

An embodiment of the disclosure provides a method in which a base station provides, to a terminal, an indication of information about a puncturing resource through an index (or an indicator, such as an ID) on a table, by using a lookup table that is pre-configured for the terminal rather than through an RRC message.

In relation to an embodiment, the lookup table may refer to information about resource patterns that are pre-configured and synchronized between a terminal and a base station.

In relation to an embodiment, the lookup table pre-configured for a terminal may be considered before receiving a first RRC message from a base station at the time of terminal setup, rather than being configured through an RRC message.

In relation to embodiment, a state before there is a definition or configuration for a resource pattern may be assumed through an RRC message and, in this case, a base station may provide, to a terminal, an indication through an index in a pre-configured table by using a pre-configured lookup table, instead of performing a separate configuration for a resource pattern in the terminal, so as to identify information about a resource pattern that is indicated to the terminal.

Parameters 1501 for the puncturing resource associated with the resource pattern may include a start symbol, a symbol length, a start PRB, a number of PRBs, a comb value, a comb offset value, and the like.

These parameters may correspond to the parameters defined in Table 16 above. Specifically, in FIG. 15, the start symbol and symbol length may correspond to the startSymbolAndLengthForPuncturing (=SLIV for puncturing) of Table 16 (this corresponds to reference numeral 1502 in FIG. 15), the start PRB and number of PRBs may correspond to the startPrbAndLengthForPuncturing (=RIV for puncturing) of Table 16 (this corresponds to reference numeral 1503 in FIG. 15), and the comb value and comb offset value may be corresponded to transmissionCombForPuncturing 1504.

In relation to an embodiment of the disclosure, a base station may provide, to a terminal, an indication of an index (or an indicator, such as an ID) on a table associated with a particular resource pattern to be identified by the terminal via an MAC CE, by using a lookup table that is pre-configured for the terminal.

In relation to an embodiment of the disclosure, a base station may provide, to a terminal, an indication of an index (or an indicator, such as an ID) on a table associated with a particular resource pattern to be identified by the terminal via DCI, by using a lookup table that is pre-configured for the terminal.

The lookup table, index, specific parameter names, etc. defined above are exemplary of this embodiment, and may be replaced by other relevant names and are not limited to the above definitions.

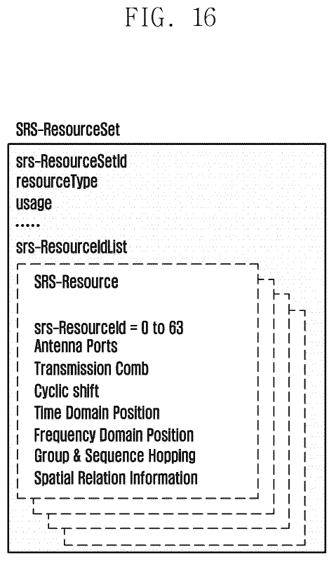

FIG. 16 illustrates an SRS resource set configuration in relation to an embodiment of the above. Hereinafter, embodiments related to FIG. 16 will be discussed in detail.

An embodiment of the disclosure in relation to FIG. 16 provides a method of defining information on a resource pattern, i.e., a puncturing resource, by utilizing information for an SRS configuration in an existing specification in an RRC message.

The information for the SRS configuration may be defined in a specific information element (IE) in an RRC message.

For example, in the RRC message, the information for the SRS configuration may include at least one of basic information for configuration of SRS transmission (e.g., SRS-config IE), and SRS resource allocation information that includes SRS resource information and information about a resource ID (e.g., SRS-Resource IE including position on the time or frequency axis, cyclic shift, transmission comb, frequency hopping information, etc., SRS-ResourceSet IE configured by SRS-Resources, SRS-ResourceSetID IE indicating an ID of each piece of information, and SRS-ResourceIDList IE including a list of IDs).

For example, the information for the SRS configuration may be configured as shown in Table 17.

TABLE 17
-- ASN1START
-- TAG-SRS-CONFIG-START

| | |
|---|---|
| SRS-Config ::= | SEQUENCE { |

| | |
|---|---|
| srs-ResourceSetToReleaseList | SEQUENCE (SIZE(1..maxNrofSRS-ResourceSets)) OF |

| | |
|---|---|
| SRS-ResourceSetId | OPTIONAL, -- Need N |

| | |
|---|---|
| srs-ResourceSetToAddModList | SEQUENCE (SIZE(1..maxNrofSRS-ResourceSets)) |

| | |
|---|---|
| OF SRS-ResourceSet | OPTIONAL, -- Need N |

| | |
|---|---|
| srs-ResourceToReleaseList | SEQUENCE (SIZE(1..maxNrofSRS-Resources)) OF SRS- |

| | |
|---|---|
| ResourceId | OPTIONAL, -- Need N |

| | |
|---|---|
| srs-ResourceToAddModList | SEQUENCE (SIZE(1..maxNrofSRS-Resources)) OF |

| SRS-Resource | OPTIONAL, -- Need N | |
|---|---|---|
| tpc-Accumulation | ENUMERATED {disabled} | OPTIONAL, -- Need |

```
S
  ...,
  [[
```

| | | |
|---|---|---|
| srs-RequestDCI-1-2-r16 | INTEGER (1..2) | OPTIONAL, -- Need S |
| srs-RequestDCI-0-2-r16 | INTEGER (1..2) | OPTIONAL, -- Need S |

| | | |
|---|---|---|
| srs-ResourceSetToAddModListDCI-0-2-r16 | SEQUENCE | (SIZE(1..maxNrofSRS- |

| | |
|---|---|
| ResourceSets)) OF SRS-ResourceSet | OPTIONAL, -- Need N |

| | | |
|---|---|---|
| srs-ResourceSetToReleaseListDCI-0-2-r16 | SEQUENCE | (SIZE(1..maxNrofSRS- |

| | |
|---|---|
| ResourceSets)) OF SRS-ResourceSetId | OPTIONAL, -- Need N |

| | | |
|---|---|---|
| srs-PosResourceSetToReleaseList-r16 | SEQUENCE | (SIZE(1..maxNrofSRS- |

| | | |
|---|---|---|
| PosResourceSets-r16)) | OF | SRS-PosResourceSetId-r16 |

OPTIONAL, -- Need N

| | | |
|---|---|---|
| srs-PosResourceSetToAddModList-r16 | SEQUENCE | (SIZE(1..maxNrofSRS- |

| | |
|---|---|
| PosResourceSets-r16)) OF SRS-PosResourceSet-r16 | OPTIONAL, -- Need N |

| | |
|---|---|
| srs-PosResourceToReleaseList-r16 | SEQUENCE (SIZE(1..maxNrofSRS-PosResources- |
| r16)) OF SRS-PosResourceId-r16 | OPTIONAL, -- Need N |

| | | |
|---|---|---|
| srs-PosResourceToAddModList-r16 | SEQUENCE | (SIZE(1..maxNrofSRS- |

| | |
|---|---|
| PosResources-r16)) OF SRS-PosResource-r16 | OPTIONAL -- Need N |

]]
}

For example, the SRS-resourceset IE exemplified by the SRS resource allocation information may be configured as shown in Table 18.

TABLE 18

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) OF SRS- |

ResourceId OPTIONAL, -- Cond Setup

| | |
|---|---|
| resourceType | CHOICE { |
| aperiodic | SEQUENCE { |

| | |
|---|---|
| aperiodicSRS-ResourceTrigger | INTEGER (1..maxNrofSRS-TriggerStates-1), |

| | | |
|---|---|---|
| csi-RS | NZP-CSI-RS-ResourceId | OPTIONAL, -- Cond NonCodebook |
| slotOffset | INTEGER (1..32) | OPTIONAL, -- Need S |

```
      ...,
      [[
```

| | |
|---|---|
| aperiodicSRS-ResourceTriggerList | SEQUENCE (SIZE(1..maxNrofSRS- |

TriggerStates-2))

| | |
|---|---|
| OF INTEGER (1..maxNrofSRS-TriggerStates-1) | OPTIONAL -- Need |

```
M
      ]]
    },
```

| semi-persistent | SEQUENCE { | |
|---|---|---|
| associatedCSI-RS | NZP-CSI-RS-ResourceId | OPTIONAL, -- Cond |

```
NonCodebook
      ...
    },
```

| periodic | SEQUENCE { | |
|---|---|---|
| associatedCSI-RS | NZP-CSI-RS-ResourceId | OPTIONAL, -- Cond |

```
NonCodebook
      ...
    }
  },
```

| | |
|---|---|
| usage | ENUMERATED {beamManagement, codebook, nonCodebook, |

antennaSwitching},

| | | |
|---|---|---|
| alpha | Alpha | OPTIONAL, -- Need S |

| | | |
|---|---|---|
| p0 | INTEGER (−202..24) | OPTIONAL, -- Cond Setup |
| pathlossReferenceRS | PathlossReferenceRS-Config | OPTIONAL, -- Need |

M

| | |
|---|---|
| srs-PowerControlAdjustmentStates | ENUMERATED { sameAsFci2, |

| | |
|---|---|
| separateClosedLoop} | OPTIONAL, -- Need S |

```
  ...,
  [[
```

| | |
|---|---|
| pathlossReferenceRSList-r16 | SetupRelease { PathlossReferenceRSList-r16} |

```
OPTIONAL -- Need M
  ]],
  [[
```

| | | |
|---|---|---|
| usagePDC-r17 | ENUMERATED {true} | OPTIONAL, -- Need R |

| | |
|---|---|
| availableSlotOffsetList-r17 | SEQUENCE (SIZE(1..4)) OF AvailableSlotOffset-r17 |

OPTIONAL, -- Need R

| | | |
|---|---|---|
| followUnifiedTCIstateSRS-r17 | ENUMERATED {enabled} | OPTIONAL - |

- Need R
]]
}

For example, SRS-resourcesetid and SRS-resource IE exemplified as the SRS resource allocation information may be configured as shown in Table 19.

TABLE 19

| SRS-ResourceSetId ::= | INTEGER (0..maxNrofSRS-ResourceSets-1) | |
|---|---|---|
| SRS-PosResourceSetId-r16 ::= | INTEGER (0..maxNrofSRS-PosResourceSets-1-r16) | |
| SRS-Resource ::= | SEQUENCE { | |
| srs-ResourceId | SRS-ResourceId, | |
| nrofSRS-Ports | ENUMERATED {port1, ports2, ports4}, | |
| ptrs-PortIndex | ENUMERATED {n0, n1 } | OPTIONAL, -- Need R |

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

sequenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| sequenceId | INTEGER (0..1023), | |
|---|---|---|
| spatialRelationInfo | SRS-SpatialRelationInfo | OPTIONAL, -- Need R |

```
  ...,
  [[
```

| | |
|---|---|
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |
| } | OPTIONAL -- Need R |

```
  ]],
  [[
```

| | |
|---|---|
| spatialRelationInfo-PDC-r17 | SetupRelease { SpatialRelationInfo-PDC-r17 } |

OPTIONAL, -- Need M

| | |
|---|---|
| resourceMapping-r17 | SEQUENCE { |
| startPosition-r17 | INTEGER (0..13), |
| nrofSymbols-r17 | ENUMERATED {n1, n2, n4, n8, n10, n12, n14}, |
| repetitionFactor-r17 | ENUMERATED {n1, n2, n4, n5, n6, n7, n8, n10, n12, n14} |
| } | OPTIONAL, -- Need R |
| partialFreqSounding-r17 | SEQUENCE { |
| startRBIndexFScaling-r17 | CHOICE{ |

| | |
|---|---|
| startRBIndexAndFreqScalingFactor2-r17 | INTEGER (0..1), |
| startRBIndexAndFreqScalingFactor4-r17 | INTEGER (0..3) |

},

| | | |
|---|---|---|
| enableStartRBHopping-r17 | ENUMERATED {enable} | OPTIONAL -- |

Need R

| | |
|---|---|
| } | OPTIONAL, -- Need R |
| transmissionComb-n8-r17 | SEQUENCE { |
| combOffset-n8-r17 | INTEGER (0..7), |
| cyclicShift-n8-r17 | INTEGER (0..5) |
| } | OPTIONAL, -- Need R |
| srs-TCIState-r17 | CHOICE { |
| srs-UL-TCIState-r17 | TCI-UL-State-Id-r17, |
| srs-DLorJoint-TCIState-r17 | TCI-StateId |
| } | OPTIONAL -- Need R |

]]
}

For example, the information for the SRS configuration may be included as information for configuring uplink resources of an RRC message. For example, the RRC message may be an RRC message associated with setup of an RRC connection (e.g., an RRC setup message), or may be an RRC message associated with reconfiguration of an RRC connection (e.g., an RRC reconfiguration message).

Additionally, the information for configuring the uplink resource may include information associated with frequency band configuration (e.g., BWP uplink configuration information).

For example, the information associated with the frequency band configuration may be information for additional uplink BWP configuration (e.g., BWP-Uplink IE) rather than the initial BWP.

For example, the information associated with the frequency band configuration may include at least one of information for configuring uplink BWP commonly applied to a specific cell (e.g., BWP-UplinkCommon IE), or information for configuring uplink BWP applied to a specific terminal (e.g., BWP-UplinkDedicated IE). In addition, the information associated with the frequency band configuration may include the position of the BWP on the frequency axis and information associated with a bandwidth, a subcarrier spacing, and a cyclic prefix.

Additionally, the information for configuring the uplink resources may be included in information configured for the terminal in relation to a serving cell (e.g., ServingCellConfig IE).

In addition, the information configured for the terminal in relation to the serving cell may be included in information for configuring a cell group (e.g., master cell group (MCG) or secondary cell group (SCG)) (e.g., CellGroupConfig IE).

Additionally, the information for configuring the cell group may be included in an RRC message associated with setup of an RRC connection (e.g., an RRC setup message) or an RRC message associated with reconfiguration of an RRC connection (e.g., an RRC reconfiguration message).

According to an embodiment, a resource pattern to be pre-configured through an RRC message to the terminal may be defined (or configured) for the terminal, by using the existing SRS resource allocation method.

Specifically, for example, puncturing a part in which SRS transmissions overlap or interference with PUSCH allocations to grant a UL grant corresponds to an embodiment related to the disclosure, and thus the SRS resource allocation information itself may be considered to be available for the terminal as information related to a resource pattern (or puncturing resource).

More specifically, the above SRS resource allocation information or information for SRS configuration in the RRC message may include fields, which are exemplified by information fields related to the periodicity of the SRS resource (e.g., resourceType field) during SRS resource allocation, or information fields related to the usage of the SRS resource (e.g., beam management, codebook, non-codebook, antenna switching) (e.g., usage field). The above fields may be elements of IEs and may be replaced by IEs.

In order to indicate that the field is an SRS resource defined for puncturing indication purposes, a process of adding a new value or element related to an embodiment of the disclosure to the field may be required.

For example, the new value may be explained as “puncturing,” for example.

Table 20 illustrates an example of a method in which a new value of “puncturing” is added to the field exemplified in the SRS resource allocation information discussed earlier to define the corresponding field as the puncturing-indication usage.

TABLE 20

```
  resourceType = {aperiodic, semi-persistent, periodic, puncturing}
  usage = {beamManagement, codebook, nonCodebook, antennaSwitching,
puncturing}
```

In relation to this example, aperiodic, semi-persistent, periodic, beamManagement, codebook, and non-codebook, which are exemplified as indicating periodicity or usage in relation to SRS resources, are exemplified as elements of existing SRS resource allocation information. Further, “puncturing” is exemplified as a new value or element, and specific values and names are not limited to the exemplified disclosure.

Additionally, the names of fields or IEs related to specific examples of the above embodiment are merely examples and may be applied to other similar fields or IEs.

An embodiment of the disclosure provides a method of establishing one or more resource patterns for a terminal, and providing, to the terminal, an indication of the resource patterns via DCI for an uplink grant (UL grant), in relation to the aforementioned embodiments. The following describes related embodiments in more detail.

In an embodiment, a field related to uplink resources may exist in the DCI for a UL grant.

For example, the field related to the uplink resource may be the PUSCH-TimeDomainResourceAllocationList field for indications related to time-axis resource allocation. Table 21 may be exemplified as IEs before the information related to the resource pattern is established with respect to the above fields of the DCI in the RRC message.

TABLE 21
-- ASN1START
-- TAG-PUSCH-TIMEDOMAINRESOURCEALLOCATIONLIST-START
PUSCH-TimeDomainResourceAllocationList ::= SEQUENCE (SIZE(1..maxNrofUL-
Allocations)) OF PUSCH-TimeDomainResourceAllocation
PUSCH-TimeDomainResourceAllocation ::= SEQUENCE {

| | | |
|---|---|---|
| k2 | INTEGER(0..32) | OPTIONAL, -- Need S |

| | |
|---|---|
| mappingType | ENUMERATED {typeA, typeB}, |
| startSymbolAndLength | INTEGER (0..127) |

}
PUSCH-TimeDomainResourceAllocationList-r16 ::= SEQUENCE (SIZE(1..maxNrofUL-
Allocations-r16)) OF PUSCH-TimeDomainResourceAllocation-r16
PUSCH-TimeDomainResourceAllocation-r16 ::= SEQUENCE {

| | | |
|---|---|---|
| k2-r16 | INTEGER(0..32) | OPTIONAL, -- Need S |

| | |
|---|---|
| puschAllocationList-r16 | SEQUENCE (SIZE(1..maxNrofMultiplePUSCHs-r16)) OF |

PUSCH-Allocation-r16,
...
}

In an embodiment, the field related to the uplink resource may correspond to a field configured in DCI format 0_0 or format 0_1.

In the case of DCI format 0_0, the field may be exemplified as including information associated with PUSCH resource scheduling in one cell on 3GPP.

In the case of DCI format 0_1, the field may be exemplified as including information associated with PUSCH resource scheduling and downlink feedback information indication in one or multiple cells on 3GPP.

Table 4 discussed above illustrates examples of some of the configuration fields of DCI format 0_0.

Time domain resource assignment field of Table 4 may include the PUSCH-TimeDomainResourceAllocationList field. Additionally, the Time domain resource assignment field may correspond to a field related to the uplink resource.

Table 5 discussed above illustrates an example of the configuration fields of DCI format 0_1.

Time domain resource assignment field of Table 5 may include the PUSCH-TimeDomainResourceAllocationList field.

Specifically, an embodiment of the disclosure provides a method of adding a new IE associated with a resource pattern in Table 21, exemplified by IEs in the RRC message associated with the PUSCH-TimeDomainResourceAllocationList field in the DCI exemplified above, configuring the same for the terminal, and then indicating a specific resource pattern (e.g., a puncturing pattern) via the aforementioned field in the DCI.

For example, Table 22 and Table 23 may be examples of configurations in IEs related to the above method.

Alt. 1-1: is exemplified as a configuration to indicate an index of “puncturing pattern configuration with Alt 1. or Alt 2. method.”

Alt 1. may be exemplified as a method relating to an embodiment in which the information about the resource pattern described above is configured for a terminal through RRC.

Alt 2. may be exemplified as a method relating to an embodiment in which the information about the resource pattern described above is configured for a terminal by utilizing SRS resource configuration information.

Further, Alt. 1-2: is exemplified as a configuration to indicate an index of “puncturing pattern configuration with Alt 3. method.”

Alt 3. may be exemplified as a method relating to an embodiment in which the information about the resource pattern is configured for a terminal by using a lookup table preconfigured for the terminal, rather than an RRC message.

TABLE 22

| | |
|---|---|
| PUSCH-TimeDomainResourceAllocation | ::= SEQUENCE { |
| k2 | INTEGER(0..32) |

OPTIONAL, -- Need S

| | |
|---|---|
| mappingType | ENUMERATED {typeA, typeB }, |
| startSymbolAndLength | INTEGER (0..127) |

// Proposed IE: Alt. 1-1

| | |
|---|---|
| puncturingResourceSetId | INTEGER (0..L-1) // L: The maximum number |

of puncturing resource set IDs
// Proposed IE: Alt. 1-2

| | |
|---|---|
| puncturingPatternIndex | INTEGER (0..M-1) // M: It depends |

on the row size of the lookup table
}

In relation to Table 22, in an embodiment, when information about the resource pattern is configured for the terminal using the above-illustrated method Alt 1. or 2., existing fields of DCI (e.g., PUSCH-TimeDomainResourceAllocationList field) may be used to specify a specific resource pattern setID in relation to Proposed IE: Alt. 1-1 of Table 22 configured in the RRC.

In relation to Table 22, in an embodiment, when information about the resource pattern is configured for the terminal using the above-illustrated method Alt 3., an existing field of DCI (e.g., PUSCH-TimeDomainResourceAllocationList field) may be used to indicate a specific index in relation to Proposed IE: Alt. 1-2 of Table 22 configured in the RRC.

TABLE 23
PUSCH-TimeDomainResourceAllocation ::= SEQUENCE {

| | |
|---|---|
| k2 | INTEGER(0..32) |

OPTIONAL, -- Need S

| | |
|---|---|
| mappingType | ENUMERATED {typeA, typeB}, |
| startSymbolAndLength | INTEGER (0..127) |

// Proposed IE: Alt. 1-1

| | |
|---|---|
| startSymbolAndLengthForPuncturing | INTEGER (0..127) // when symb. |

length = 14

| | |
|---|---|
| startPrbAndLengthForPuncturing | INTEGER // depends on the total # of PRBs |
| transmissionCombForPuncturing | // refer to transmissionComb IE |

// Proposed IE: Alt. 1-2

| | |
|---|---|
| puncturingPatternIndex | INTEGER // depends on the table size |

}

In relation to Table 23, in an embodiment, when information about the resource pattern is configured for the terminal using the above-illustrated method Alt 1. or 2., existing fields of DCI (e.g., PUSCH-TimeDomainResourceAllocationList field) may be used to indicate puncturing resource values (e.g., startSymbolAndLengthForPuncturing, startPrbAndLengthForPuncturing, transmissionCombForPuncturing values) in relation to Proposed IE: Alt. 1-1 in Table 23 configured in the RRC.

In relation to Table 23, in an embodiment, when information about the resource pattern is configured for the terminal using the above-illustrated method Alt 3., existing fields of DCI (e.g., PUSCH-TimeDomainResourceAllocationList field) may be used to indicate a specific index in relation to Proposed IE: Alt. 1-2 of Table 23 configured in the RRC.

In relation to an embodiment, the transmissioncomb IE above may be configured as shown in Table 24.

TABLE 24

| transmissionComb CHOICE { | |
|---|---|
| n2 | SEQUENCE { |
| combOffset-n2 | INTEGER (0..1), |
| cyclicShift-n2 | INTEGER (0..7) |
| }, | |
| n4 | SEQUENCE { |
| combOffset-n4 | INTEGER (0..3), |
| cyclicShift-n4 | INTEGER (0..11) |

}
}

Additionally, the IE name or index may be changed and is not limited to the above definition.

An embodiment of the disclosure provides a method of indicating a resource pattern to a terminal by adding a new field for indicating a resource pattern in relation to an embodiment of the disclosure in the configuration of field in the DCI discussed above. The following describes the relevant embodiments in more detail.

According to an embodiment, a method is provided in which a field configured in DCI format 0_0 or format 0_1 may be newly configured using a new field.

For example, a method of indicating a resource pattern by adding a new field may be applied differently depending on the various embodiments of configuring one or more resource patterns for a terminal discussed above.

Alt 1. may be exemplified as a method related to an embodiment of configuring information about the resource pattern discussed above in a terminal through RRC.

Alt 2. may be exemplified as a method related to an embodiment in which the information about the resource pattern discussed above is configured in a terminal by using the SRS resource configuration information.

In this case, the added new field may be exemplified as indicating puncturingResourceSetId or SRS-ResourceSetId (indicating IDs or parameters, etc. exemplified in FIGS. 14 and 16).

Alt 3. may be exemplified as a method related to an embodiment in which information about the resource pattern described above is configured for the terminal by using a lookup table preconfigured for the terminal rather than an RRC message.

In this case, the added field may be exemplified as indicating puncturingPatternIndex (indicating Index, etc. on the lookup table illustrated in FIG. 15)

Table 25 illustrates the configuration of a new field related to the resource pattern proposed in this embodiment in the DCI format 0_0 or format 0_1 illustrated above.

TABLE 25
(...)

| | |
|---|---|
| - | Time domain resource assignment - 0, 1, 2, 3, or 4 bits as defined in Subclause 6.1.2.1 |
| | of [6, TS38.214]. The bitwidth for this field is determined as log₂(I) bits, where I the |
| | number of entries in the higher layer parameter pusch-AllocationList. |
| - | puncturing pattern - L or M bits when “puncturing pattern configuration with Alt |
| | 1, Alt 2, or Alt 3 method” is adopted, respectively |
| - | Frequency hopping flag - 0 or 1 bit: |

(...)

The format in which the new field may be configured is not limited to the DCI format 0_0 or 0_1 suggested above and may be configured in any one of the DCI formats.

Additionally, the field name or index may be changed and is not limited to the above definition.

In an embodiment of the disclosure, a specific method is disclosed in which a base station and the like provides an indication regarding a resource pattern to be indicated to a terminal, for which information on one or more resource patterns is configured, through a medium access control (MAC) control element (CE) message. In the following, relevant embodiments will be described in detail.

Because SRS resources are configured periodically, the resource pattern may be maintained statically rather than dynamically changed in each slot.

In this case, an MAC CE may be used to activate/update/deactivate the resource pattern.

The MAC CE may be described as a control element that transmits control information in the MAC layer. The MAC CE may be distinguished through an ID (e.g., logical channel ID (LCID)), an index, or a codepoint value.

For example, Table 26 illustrates that multiple MAC CEs for a downlink data transmission channel (downlink shared channel (DL-SCH)) are displayed separately by an LCID, a codepoint, or an index.

TABLE 26

| Code | LCID |
|---|---|
| point/Index | values |
| 0 | CCCH |
| 1-32 | Identity of the logical channel of DCCH, DTCH and multicast MTCH |
| 33 | Extended logical channel ID field (two-octet eLCID field) |
| 34 | Extended logical channel ID field (one-octet eLCID field) |
| 35-46 | Reserved |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specificPDSCH |
| 54 | Aperiodic CSI Trigger State Subselection |
| 55 | SP CSI-RS/CSI-IM Resource Set Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

The range of an index or codepoint according to an embodiment of the disclosure may be configured by 6 bits or octets. For example, an LCID related to a specific or new MAC CE may be defined or aligned in octets, and the remaining octets after being defined or aligned may be configured in the form of “reserved” or the like. For example, the LCID may be configured to be defined or aligned to indicate a specific or new MAC CE in octets, and the remaining part of the octet may be configured in the form exemplified by “reserved” or the like in the LCID. For example, a MAC CE may be identified through a specific LCID.

A new MAC CE indicating a resource pattern ID according to an embodiment of the disclosure may be defined. In addition, the newly defined MAC CE in the above according to embodiment may be indicated by any one value among the indices corresponding to the “reserved” LCDI value in Table 26 above. For example, a case, in which an index corresponding to the LCID value is indicated by a value of 40, may be regarded as indicating a MAC CE according to an embodiment of the disclosure.

For example, there may be a method of indicating a newly defined MAC CE related to the resource pattern of an embodiment of the disclosure by using the “reserved” index or LCID value. As an example, a method in which, for a terminal pre-configured with a resource pattern, an index or LCID reserved by an existing MAC CE is used to define a new LCID and a specific resource pattern is indicated through the corresponding MAC CE.

Specifically, the newly defined MAC CE or the resource pattern transmitted or indicated through the MAC CE may correspond to information, such as a resource pattern ID, a puncturing resource, a puncturing resource ID, or a puncturing resource set, which are exemplified in the previous embodiment, and may correspond to any information associated with the resource pattern instead of being limited to a specific resource pattern ID.

As a specific example, there may be exemplified by a method of using an existing reserved index or LCID defined in the existing 5G standard, or a method of using an index or LCID that may be added in 6G.

As an example related to the 6G, it is possible to consider a method of defining a new MAC CE related to a resource pattern through a newly configured index, codepoint, and LCID rather than using the existing “reserved” LCID and indicating the resource pattern to the terminal through the defined new MAC CE.

In the 6G, the index value indicating the LCID may be configured by n bits in the form of bits (binary digits).

In an embodiment, a value of n may be determined according to a range of the illustrated LCID. For example, when a range of the ID related to the resource pattern described in the previous embodiment corresponds to 16, the index value may be configured by 4 bits, and when a range of the ID corresponds to 64, the index value may be configured by 6 bits. Alternatively, the index value may be configured by specific bits regardless of the range related to the LCID, and the positions of the remaining bits excluding the range of each LCID may be configured as exemplified by “reserved” and the like.

As for the method of indicating a resource pattern to the terminal through the illustrated MAC CE, different methods may be applied depending on the various embodiments of configuring one or more resource patterns to the terminal, described above.

As a specific example, in the case of Alt 1. and Alt 2., which may be defined as examples above, an example of an ID (e.g., LCID) in a list of MAC CE-related indexes may be configured as “puncturing pattern configuration with Alt 1. or Alt 2. method.”

As a specific example, in the case of Alt 1. and Alt 2. which may be defined in the preceding example, the ID (e.g., LCID) in a list of MAC CE-related indexes may be exemplified to be configured by “puncturing pattern configuration with Alt 1. or Alt 2. method.”

As a specific example, in the case of Alt 3. defined as an example above, the ID (e.g., LCID) in a list of MAC CE-related indexes is configured by “puncturing pattern configuration with Alt 3. method.”

As a specific example, as a value configured by a puncturing resource, startSymbol AndLengthForPuncturing, startPrbAndLengthForPuncturing or transmissionCombForPuncturing are configured in a list of MAC CE-related indexes, that is, configuration information configured by the above-exemplified puncturing resources may be configured through the MAC CE.

The configuration configured through the MAC CE in the above example is only an example, and the name or the index, codepoint, LCID, etc. exemplified as distinguishing the MAC CE or indicating a specific MAC CE may be changed and are not limited to the above definition.

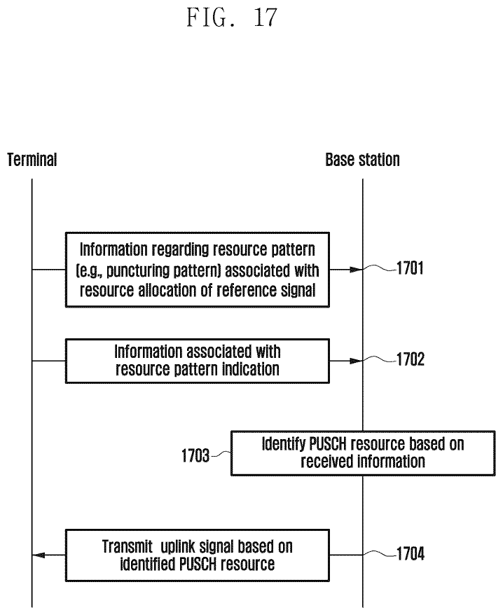

FIG. 17 discloses a series of signaling processes related to an embodiment of the disclosure, such as a process of configuring a resource pattern and indicating a resource pattern through a process of transmitting and receiving information about a resource pattern between a terminal and a base station and the like.

First, the base station may transmit information about resource patterns (e.g., a puncturing pattern, an RE puncturing pattern, and a rate match pattern) related to resource allocation of a reference signal (RS) to the terminal (indicated by reference numeral 1701).

This operation includes a process in which the base station transmits, to the terminal, information regarding a resource pattern that is predefined as a primarily used pattern or a specific pattern with respect to a resource pattern related to resource allocation of the reference signal.

The information associated with the resource pattern may be transmitted to the terminal through an RRC message, according to an embodiment.

According to an embodiment, the information associated with the resource pattern may be pre-configured in a terminal in a lookup table scheme during initial setup, instead of being transmitted to the terminal through an RRC message. In this case, the transmission operation of the corresponding resource pattern may be omitted.

After information about the resource pattern is configured for the terminal through the information transmission, the base station and the like may transmit information associated with an indication of a specific resource pattern to the terminal (indicated by reference numeral 1702).

According to an embodiment, the information associated with the indication may be transmitted to the terminal through DCI or may be transmitted to the terminal through MAC CE.

The information associated with the indication is information about resource patterns, and may be exemplified in the form of a puncturing resource, puncturingResourceSetId, puncturingPatternIndex, and the like.

The terminal that has received information associated with the resource pattern indication may identify a PUSCH resource based on the received information (indicated by reference numeral 1703).

The identification 1703 of the PUSCH resource may be omitted by other configuration or information, or may be combined with a process of identifying additional other resources.

After the identification 1703 of the PUSCH resource, the terminal may transmit an uplink (UL) signal to the base station based on the identified PUSCH resource.

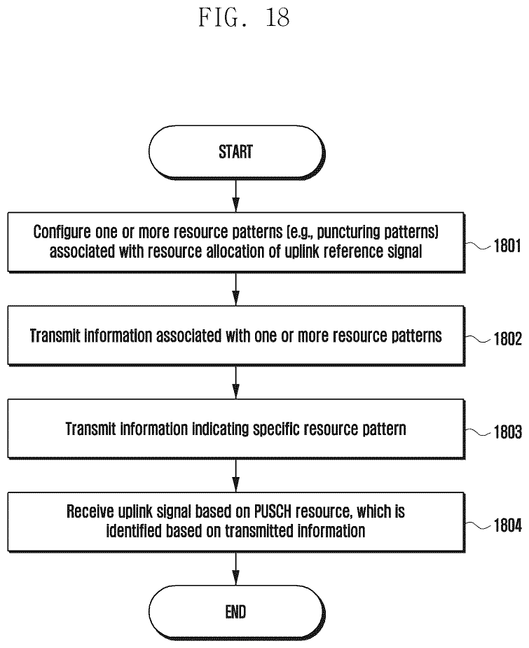

FIG. 18 discloses a series of processes related to an embodiment of the disclosure, such as a process of configuring a resource pattern and indicating a resource pattern through a process of transmitting and receiving information about a resource pattern performed by a base station and the like.

First, the process includes an operation in which the base station predefines resource patterns, which are related to resource allocation of reference signals to the terminal, as primarily used patterns or specific patterns (indicated by reference numeral 1801).

Next, the base station transmits, to the terminal, information on multiple resource patterns defined earlier (e.g., a puncturing pattern, an RE puncturing pattern, and a rate match pattern) associated with resource allocation of the reference signal (RS) (indicated by reference numeral 1802).

The information associated with the resource pattern may be transmitted to the terminal through an RRC message according to an embodiment.

According to an embodiment, the information associated with the resource pattern may be pre-configured in the terminal in a lookup table scheme during initial setup, instead of being transmitted to the terminal through an RRC message. In this case, the transmission operation of this resource pattern may be omitted.

After information about the resource pattern is configured for the terminal through transmission of the information, the base station and the like may transmit information associated with an indication of a specific resource pattern to the terminal (indicated by reference numeral 1803).

According to an embodiment, the information associated with the indication may be transmitted to the terminal through DCI or may be transmitted to the terminal through MAC CE.

Next, the process may include an operation of receiving an uplink signal from the terminal based on the PUSCH resource, which is identified based on previously transmitted information (indicated by reference numeral 1804).

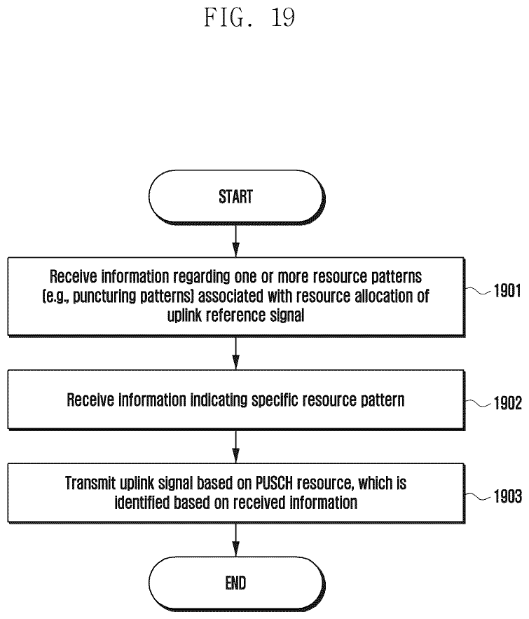

FIG. 19 discloses a series of processes related to an embodiment of the disclosure, such as a process of configuring a resource pattern and indicating a resource pattern through a process of receiving information about a resource pattern performed by a terminal.

First, the process includes an operation of receiving, from a base station, information about multiple resource patterns (e.g., a puncturing pattern, a RE puncturing pattern, a rate match pattern) related to resource allocation of the reference signal.

According to an embodiment, information associated with the resource pattern may be received by the terminal through an RRC message.

According to an embodiment, the information associated with the resource pattern may be pre-configured in the terminal in a lookup table scheme during initial setup, instead of being received by the terminal through an RRC message. In this case, the receiving of this resource pattern may be omitted.

After information about the resource pattern is configured through the information transmission, information associated with an indication of a specific resource pattern may be received (indicated by reference numeral 1902).

According to an embodiment, the information associated with the indication may be transmitted to the terminal through DCI, or may be transmitted to the terminal through MAC CE.

The information associated with the indication corresponds to information about resource patterns, and may be exemplified in the form of a puncturing resource, a puncturingResourceSetId, a puncturingPatternIndex, and the like.

The terminal that has received information associated with the resource pattern indication may include a process of identifying a PUSCH resource based on the received information.

The identification of the PUSCH resource may be omitted by other configuration or information or may be combined with the identification process of additional other resources.

After identification of the PUSCH resource, the terminal may transmit an uplink (UL) signal to the base station based on the identified PUSCH resource (indicated by reference numeral 1903).

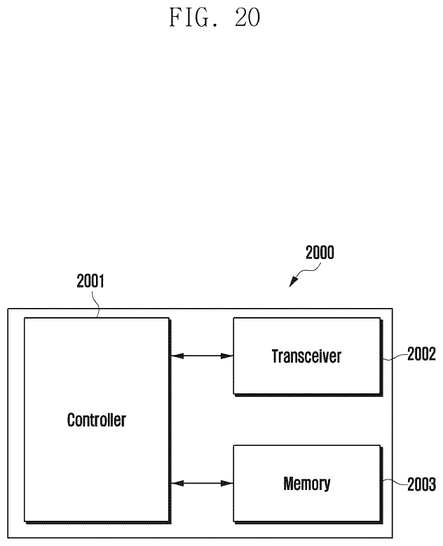

FIG. 20 illustrates an example of the structure of a terminal according to an embodiment of the disclosure.

Referring to FIG. 20, a terminal 2000 according to an embodiment of the disclosure may include a controller 2001, a transceiver 2002, and a memory 2003. In the disclosure, the controller 2001 of the terminal 2000 may be defined as a circuit, an application-specific integrated circuit, or at least one processor.

The controller 2001 may control overall operations of the terminal 2000 according to an embodiment provided in this disclosure. For example, the controller 2001 may control a signal flow between respective blocks to perform operations according to the drawings (or sequential diagrams or flowcharts) described above.

The transceiver 2002 may transmit and receive signals. For example, the transceiver 2002 may transmit a signal to a node or base station and receive a signal from the node or base station according to an embodiment of the disclosure.

The memory 2003 may store at least one of information transmitted and received through the transceiver 2002 and information generated through the controller 2001. Additionally, the memory 2003 may be defined as a storage.

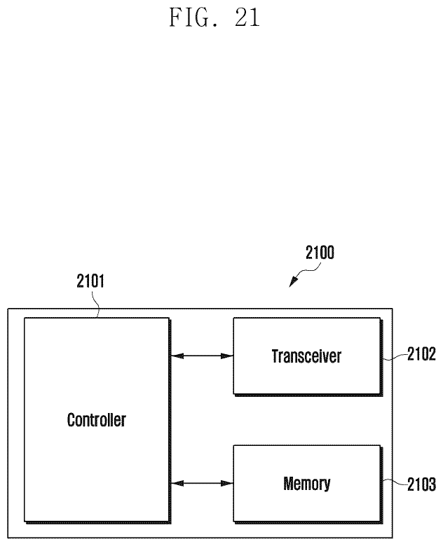

FIG. 21 illustrates the structure of a base station to which the disclosure may be applied.

Referring to FIG. 21, a base station 2100 according to an embodiment of the disclosure may include a controller 2101, a transceiver 2102, and a memory 2103. In the disclosure, the controller 2101 of the base station 2100 may be defined as a circuit, an application-specific integrated circuit, or at least one processor.

The controller 2101 may control overall operations according to an embodiment provided in this disclosure. For example, the controller 2101 may control a signal flow between respective blocks to perform operations according to the drawings (or sequential diagrams or flowcharts) described above.

The transceiver 2102 may transmit and receive signals. For example, the transceiver 2102 may transmit a signal to a terminal or node and receive a signal from the terminal or node according to an embodiment of the disclosure.

The memory 2103 may store at least one of information transmitted and received through the transceiver 2102 and information generated through the controller 2101. Additionally, the memory 2103 may be defined as a storage.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Moreover, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port.

Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented.

Furthermore, the above respective embodiments may be employed in combination, as necessary.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

Furthermore, in methods of the disclosure, some or all of the contents of each embodiment may be combined without departing from the essential spirit and scope of the disclosure.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Furthermore, the above respective embodiments may be employed in combination, as necessary. For example, all embodiments of the disclosure may be partially combined to operate a base station and a terminal.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, first information on at least one resource pattern associated with a resource allocation of an uplink reference signal (RS);
receiving, from the base station, second information indicating a resource pattern among the at least one resource pattern;
based on the first information and the second information, identifying a physical uplink shared channel (PUSCH) resource; and
based on the identified PUSCH resource, transmitting, to the base station, an uplink signal.

2. The method of claim 1, wherein the first information is received from the base station through a radio resource control (RRC) message.

3. The method of claim 1, wherein the first information is configured by a list comprising at least one identifier (ID) associated with the at least one resource pattern.

4. The method of claim 1, wherein the second information is received from the base station through downlink control information (DCI).

5. The method of claim 1, wherein the second information is received from the base station through a medium access control control element (MAC CE) message.

6. A method performed by a base station in a wireless communication system, the method comprising:
transmitting, to a terminal, first information on at least one resource pattern associated with a resource allocation of an uplink reference signal (RS);
transmitting, to the terminal, second information indicating a resource pattern among the at least one resource pattern; and
receiving, from the terminal, an uplink signal based on a physical uplink shared channel (PUSCH) resource, which is identified based on the first information and the second information.

7. The method of claim 6, wherein the first information is transmitted to the terminal through a radio resource control (RRC) message.

8. The method of claim 6, wherein the first information is configured by a list comprising at least one identifier (ID) associated with the at least one resource pattern.

9. The method of claim 6, wherein the second information is transmitted to the terminal through downlink control information (DCI).

10. The method of claim 6, wherein the second information is transmitted to the terminal through a medium access control control element (MAC CE) message.

11. A terminal in a wireless communication system, the terminal comprising:
a transceiver; and
at least one processor coupled with the transceiver and configured to:
receive, from a base station, first information on at least one resource pattern associated with a resource allocation of an uplink reference signal (RS),
receive, from the base station, second information indicating a resource pattern among the at least one resource pattern,
based on the first information and the second information, identify a physical uplink shared channel (PUSCH) resource, and
based on the identified PUSCH resource, to the base station, transmit an uplink signal.

12. The terminal of claim 11, wherein the first information is received from the base station through a radio resource control (RRC) message.

13. The terminal of claim 11, wherein the first information is configured by a list comprising at least one identifier (ID) associated with the at least one resource pattern.

14. The terminal of claim 11, wherein the second information is received from the base station through downlink control information (DCI).

15. The terminal of claim 11, wherein the second information is received from the base station through a medium access control control element (MAC CE) message.

16. A base station in a wireless communication system, the base station comprising:
a transceiver; and
at least one processor coupled with the transceiver and configured to:
transmit, to a terminal, first information on at least one resource pattern associated with a resource allocation of an uplink reference signal (RS),
transmit, to the terminal, second information indicating a resource pattern among the at least one resource pattern, and
receive, from the terminal, an uplink signal based on a physical uplink shared channel (PUSCH) resource, which is identified based on the first information and the second information.

17. The base station of claim 16, wherein the first information is transmitted to the terminal through a radio resource control (RRC) message.

18. The base station of claim 16, wherein the first information is configured by a list comprising at least one identifier (ID) associated with the at least one resource pattern.

19. The base station of claim 16, wherein the second information is transmitted to the terminal through downlink control information (DCI).

20. The base station of claim 16, wherein the second information is transmitted to the terminal through a medium access control control element (MAC CE) message.
